(19) United States
(12) Patent Application Publication
(10) Pub. No.: US 2012/0164036 A1
(43) Pub. Date: Jun. 28, 2012

(54) MICROFLUIDIC DEVICES AND USES THEREOF

(76) Inventors: Seth Stern, Palo Alto, CA (US); Greg Bogdan, San Jose, CA (US); David Eberhart, Santa Clara, CA (US)

(21) Appl. No.: 13/384,753

(22) PCT Filed: Jun. 29, 2010
(86) PCT No.: PCT/US10/40490

§ 371 Date: Mar. 15, 2012

Related U.S. Application Data
(60) Provisional application No. 61/227,409, filed on Jul. 21, 2009.

(51) Int. Cl. B01L 3/00

(52) U.S. Cl. 422/502

(57) ABSTRACT

The invention provides for devices and methods for interfacing microchips to cartridges and pneumatic manifolds. The design of the cartridges, microchips, and pneumatic manifolds can allow for the use of magnetic forces to capture magnetic beads in a chamber formed between the microchip and the cartridge or a chamber within the microchip. The devices of the invention can be used for mRNA amplification and purification.

CROSS-REFERENCE

This application claims the benefit of the filing date of U.S. Provisional Patent Application 61/227,409 filed on Jul. 21, 2009.

### STATEMENT OF JOINT DEVELOPMENT

This invention was created pursuant to a joint research agreement between IntegenX, Inc. and Samsung Electronic Co., Ltd.

### BACKGROUND OF THE INVENTION

Microfluidic platforms have been developed to perform molecular biology protocols on chips. Typically, microfluidic platforms have utilized conventional lithography with hard materials and have relied on electrokinetic or pressure-based fluid transport, both of which are difficult to control and provide extremely limited on-chip valving and pumping options. Other platforms have utilized soft-lithography methods that have been plagued by problems related to absorption, evaporation, and chemical compatibility.

It is therefore desirable to provide improved methods and apparatus for implementing microfluidic control mechanisms such as valves, pumps, routers, reactors, etc. to allow effective integration of sample introduction, preparation processing, and analysis capabilities in a microfluidic device.

### SUMMARY OF THE INVENTION

The invention provides for a device comprising a cartridge; a microfluidic chip having one or more microfluidic diaphragm valves, fluidically interfaced with the cartridge; and a base comprising a support structure, one or more temperature controlling devices that are in thermal contact with the cartridge, and pneumatic lines for pneumatically actuating the microfluidic chip.

In some embodiments, the base further comprises a pneumatic floater that is positioned within the support structure. In other embodiments, the pneumatic floater is supported by springs that force the pneumatic floater toward the microfluidic chip. The pneumatic floater may supported by springs that allow for an air-tight seals between the pneumatic floater and the microfluidic chip. In some embodiments, the support structure is rigid. The base may further comprise a pneumatic insert that is fluidically connected with the cartridge. In some instances, the cartridge comprises a thermistor. The cartridge can be formed from cyclic olefin copolymer. The cartridge may be injection molded. In some embodiments, the support structure is a heat sink.

In other embodiments, the device further comprises a pneumatic manifold mounted on the base, wherein the pneumatic manifold comprises vias or channels that are in pneumatic communication with the pneumatic lines and with pneumatic ports on the microfluidic chip to deliver pressure or vacuum to the chip to actuate the diaphragm valves, and wherein the pneumatic manifold is mounted on the support in a configuration biased to engage the chip and to allow the temperature controlling devices also to be in thermal contact with the cartridge.

The invention provides for a device comprising a microfluidic chip having one or more pneumatically actuated valves and one or more chambers; and a cartridge, wherein the cartridge comprises one or more reservoirs that are fluidically connected with the chambers and the reservoirs are sized such that a material can be directly pipetted into the chamber.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 depicts a device with a cartridge, microfluidic chip, and a magnet.

FIG. 2 depicts a fluidic manifold encased by an aluminum bezel.

FIG. 3 shows a photograph of four thermoelectric coolers and a heat distributing device mounted onto a fluidic manifold.

FIG. 4A shows a thermoelectric cooler coupled to a heat sink, a fan, and a manifold.

FIG. 4B shows four thermoelectric coolers coupled to an electrical power supply.

FIG. 5 shows an exploded view of a reservoir, chip, pneumatic floater, pneumatic inserts, thermoelectric coolers, and an aluminum manifold.

FIG. 6 shows an assembled view of the system shown in FIG. 5.

FIG. 7 shows a top view and a bottom view of a fluidic manifold.

FIG. 8 shows a photograph of a fluidic manifold mounted to a base.

FIG. 9 shows a top view of a fluidic manifold.

FIG. 10 shows a side view of a base with thermoelectric coolers and a pneumatic floater.

FIG. 11 shows an exploded view of a fluidic manifold formed from injection molded cyclic olefin copolymer.

FIG. 12 shows multiple views of a fluidic manifold formed from injection molded cyclic olefin copolymer.

FIG. 13 shows an exploded view of a TEC stack, a fluidic manifold, a microfluidic chip and a pneumatic manifold.

FIG. 14 depicts a microfluidic chip with a fluidics layer, an elastomeric layer, and a pneumatics layer.

FIG. 15 depicts a microscale on-chip valve (MOVe).

FIG. 16 depicts a fluidics layer made of two layers of material.

FIG. 17 depicts a fluidics layer made of a single layer of material.

FIG. 18 depicts fluidics and pneumatic layers of a microfluidic chip with a reagent and bead rail.

FIG. 19 depicts fluidics layers of a microfluidic chip with a reagent and bead rail.

FIG. 20 shows four stages (A, B, C, D) of a pumping cycle.

FIG. 21 shows a photograph of a system without pipette tips or TEC-tip manifold.

FIG. 22 shows a pneumatic manifold with cutouts for magnet cradles.

FIG. 23 shows pneumatic routing control of valves and pumps.

FIG. 24 shows a reaction scheme for preparing and analyzing an mRNA sample.

FIG. 25 depicts a reaction scheme for amplifying mRNA.

FIG. 26 shows a script for performing mRNA amplification.

FIG. 27 shows a script for performing the Eberwine process.

FIG. 28 shows experimental results for RNA purification using 0.125 uL SpeedBeads.

FIG. 29 shows experimental results for RNA purification using 0.125/4 uL SpeedBeads.

FIG. 30 shows experimental results for RNA purification using 0.125/40 uL SpeedBeads.

FIG. 31 shows experimental results for determining bead mixing accuracy.

FIG. 32 shows the results of three purification experiments with approximately 1.5 ug total RNA in a microfluidic chip.

FIG. 33 shows bus channel cutoff.

FIG. 34 shows the distribution of beads as a function of amount of RNA bound to them.

FIG. 35 shows the distribution of beads as a function of bead quantity.

FIG. 36 shows a table of how various experiments were configured.

FIG. 37 shows results from Experiment 1 and Experiment 2.

FIG. 38 shows results from Experiment 1 and Experiment 3.

FIG. 39 shows tables that summarize yield and amplification factors.

FIG. 40 shows results from Experiment 1 and Experiment 4.

FIG. 41 shows results from Experiment 1 and Experiment 5.

FIG. 42 shows the experimental design for a microarray analysis experiment.

FIG. 43 shows tables of aRNA yields for bench and chip generated samples

FIG. 44 shows graphs bBioanalyzer electropherograms of the samples before and after fragmentation.

FIG. 45 shows results of the experiments in a 4×4 comparison matrix.

FIG. 46 shows a comparison of chip results to bench results.

FIG. 47 shows that chip and bench fragmentation are indistinguishable.

### DETAILED DESCRIPTION OF THE INVENTION

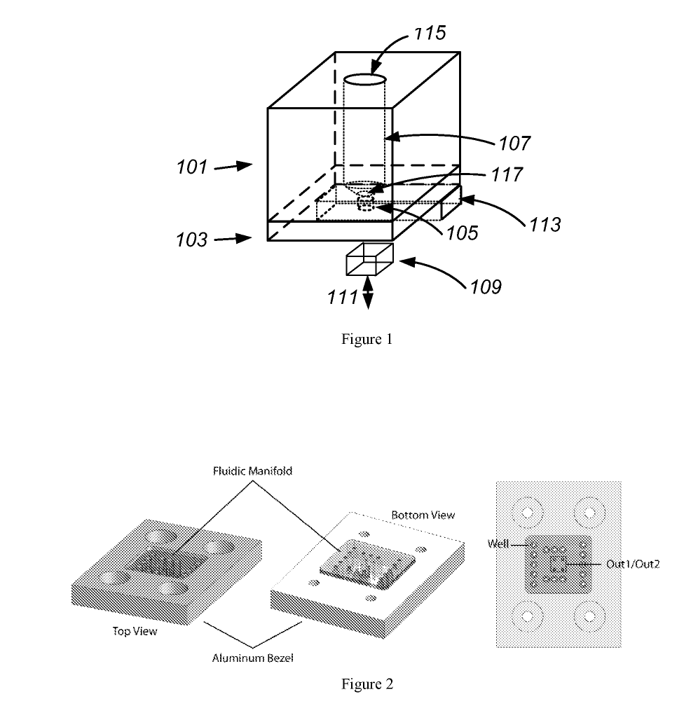

The invention provides devices for fluid and analyte processing and methods of use thereof. The devices of the invention can be used to perform a variety of actions on the fluid and analyte. These actions can include moving, mixing, separating, heating, cooling, and analyzing. The devices can include multiple components, such as a cartridge, a microfluidic chip, and a pneumatic manifold. FIG. 1 shows an exemplary device having a cartridge (101), microfluidic chip (103), and pneumatic manifold (113). These devices can be used to prepare samples for analysis by gene expression microarrays and to perform biochemical and enzymatic reactions for other purposes.

### I. Device Components

### A. Cartridges

A cartridge, also referred to as a fluidic manifold herein, can be used for a number of purposes. In general, a cartridge can have ports that are sized to interface with large scale devices as well as microfluidic devices. Cartridges or fluidic manifolds have been described in U.S. Patent Application No. 61/022,722, which is hereby incorporated by reference in its entirety. The cartridge can be used to receive materials, such as samples, reagents, or solid particles, from a source and deliver them to the microfluidic chip. The materials can be transferred between the cartridge and the microfluidic chip through mated openings of the cartridge and the microfluidic chip. For example, a pipette can be used to transfer materials to the cartridge, which in turn, can then deliver the materials to the microfluidic device. In another embodiment, tubing can transfer the materials to the cartridge. In addition, a cartridge can have reservoirs with volumes capable of holding nanoliters, microliters, milliliters, or liters of fluid. The reservoirs can be used as holding chambers, reaction chambers (e.g., that comprise reagents for carrying out a reaction), chambers for providing heating or cooling (e.g., that contain thermal control elements or that are thermally connected to thermal control devices), or separation chambers (e.g. paramagnetic bead separations, affinity capture matrices, or chromatography). Any type of chamber can be used in the devices described herein, e.g. those described in U.S. Patent Publication Number 2007/0248958, which is hereby incorporated by reference. A reservoir can be used to provide heating or cooling by having inlets and outlets for the movement of temperature controlled fluids in and out of the cartridge, which then can provide temperature control to the microfluidic chip. Alternatively, a reservoir can house Peltier elements, or any other heating or cooling elements known to those skilled in the art, that provide a heat sink or heat source. A cartridge reservoir can have a volume of at least about 0.1, 0.5, 1, 5, 10, 50, 100, 150, 200, 250, 300, 400, 500, 750, 1000, 2000, 3000, 4000, 5000 or more μL.

For example, FIG. 1 shows cartridge (101) with a reservoir with a port (115) opening to a side of the cartridge that can be used to receive materials from a pipette or any other large scale device. The port can also be adapted with fitting to receive tubing or a capillary to connect the cartridge to upstream fluidics. The reservoir can taper down to form a cartridge reservoir opening (117) that interfaces or aligns with an opening 105 in the fluidics layer of the microfluidic chip. The cartridge can have a reservoir that is sized to be larger than a pipette tip, such that a material can be pipetted directly into the microfluidic chip.

Each chip can be attached to the bottom surface of a Fluidic Manifold with silicone pressure sensitive adhesive (laser cut PSA, not shown). As noted above, a Fluidic Manifold can be designed to use pipette tips both as fluid input/output ports, and as incubation reservoirs. The tips can be friction-fit or jammed into the machined holes on the top surface of the manifold. This may create trapped air dead volumes in the manifold.

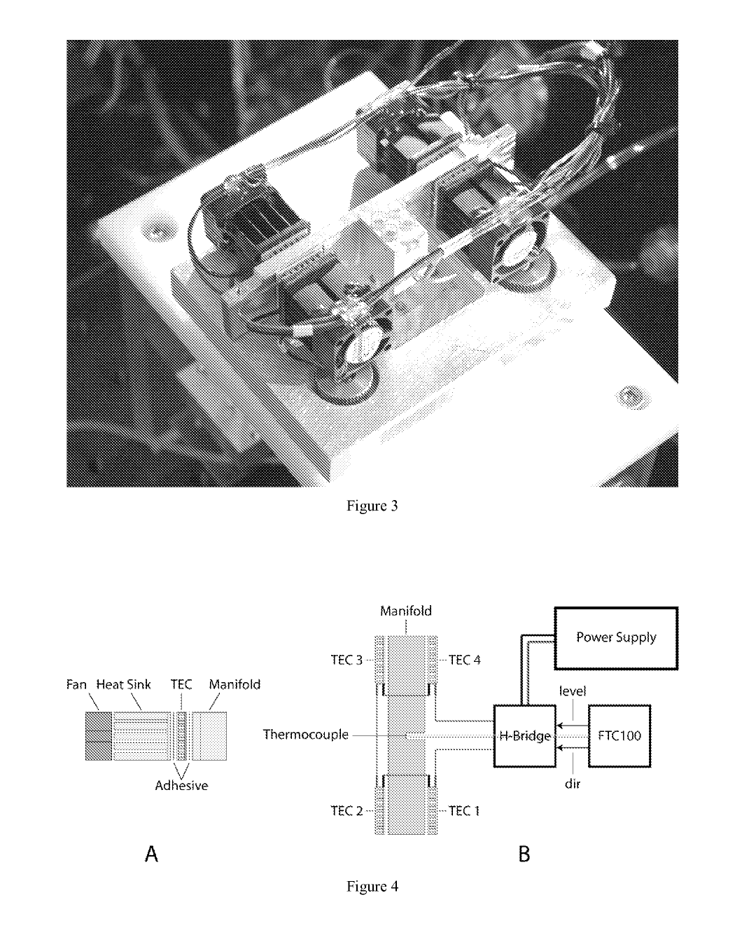

FIG. 2 shows a Fluidic Manifold system with a two piece design, including an aluminum bezel. This can reduce temperature-induced warping of manifolds, such as polycarbonate (PC) manifolds. The small PC fluidic manifold, housed in the aluminum bezel, can be modified with large diameter holes that function as reagent wells (without pipette tips). These enlarged holes can permit pipetting of reagents directly into chip wells. This feature can eliminate air dead volumes in reagent wells, and greatly reduces the number of priming cycles required, compared with the original design. Holes labeled Out1/Out2 can be interfaced with a pipette tip. FIG. 3 is a photograph of a complete system, including TEC-Tip Manifold with four TEC stacks.

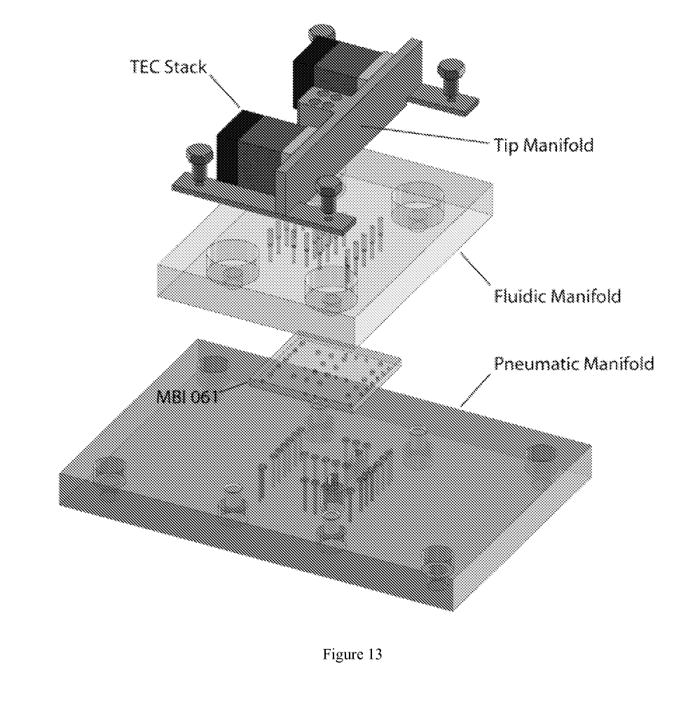

As shown in FIG. 4, the TEC-Tip Manifold can comprise an aluminum manifold and multiple “TEC stacks.” As shown in FIG. 4A, a Peltier TEC can be attached to heat sink and to manifold with heat-conductive PSA. A Fan can be glued to heat sink fins. As shown in FIG. 4B, Four series connected TECs can be connected to H-Bridge. H-Bridge can rout power to TECs in response to signals from FTC100 controller. The aluminum manifold can have four holes drilled in its center to house the four pipette tips connected to chip Out1 and Out2 wells. As described above, the tips can function as reservoirs for mixing and incubation steps. The purpose of the TEC-Tip Manifold can be to control the temperature of incubations over a range of 16C to 65C. Temperature can be controlled through the action of “TEC stacks” attached to the aluminum manifold, as shown in FIG. 3 and FIG. 13. As shown in FIG. 4A, each stack can comprise three main parts: Peltier TEC, heat sink, and fan. As illustrated in FIG. 4B, the TEC stacks can either heat or cool the manifold in response to current supplied by the H-Bridge. The H-Bridge can be controlled by two signals (level and direction) from the FTC100 controller, which implements a PID control system. The FTC100 can compute values for these signals based on the temperature of the manifold, as measured by a thermocouple implanted in it, user programmed set point, and PID parameters: P (proportional), I (integral), and D (differential). PID parameters can be set automatically using the Autotune function of the FTC100. The minimum operating voltage of the H-Bridge may be 7 volts, which may require a series connection of the four TECs, each rated at 3 volts maximum. The system can be typically operated at 8 volts for cooling and heating to 40C. Higher voltages (up to 12 volts) could be used for heating to 65C and above. Fans can be driven continuously by a separate 5 volt power supply.

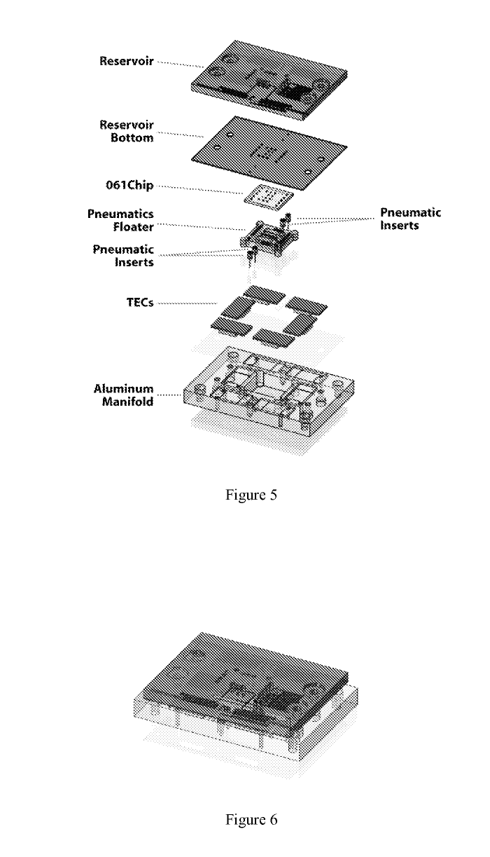

The systems, devices, and methods described herein can be pipette-free. Reservoirs can be designed to be included within the cartridge, or any other component, such that pipettes are not needed. An example of such a system is shown in FIG. 5 and FIG. 6.

FIG. 5 shows a system comprising a base, e.g., an aluminum manifold, that supports other structures and that can function as a heat sink. Thermal regulators, e.g., thermoelectric couplers, are mounted on the base and are in thermal contact with the base, e.g., to allow heat exchange.

A pneumatic manifold comprising vias, e.g., a pneumatic floater, also is mounted on the base. It can be biased, e.g., with springs, so that it can make a pressurized seal with a microfluidic chip. Pneumatic inserts can engage vias in the pneumatic manifold on the side that does not engage the microfluidic chip. The pneumatic inserts communicate with pneumatic lines that supply pressure (positive or negative) to the pneumatic layer of the microfluidic chip.

A microfluidic device is mounted on the base. The microfluidic device includes a microfluidic chip and a cartridge, e.g. a reservoir. The microfluidic chip comprises a fluidic layer, a pneumatic layer and an elastic layer sandwiched between them. The fluidic layer comprises microfluidic channels that open on an outside surface of the fluidic layer and an inside surface of the fluidic layer. The pneumatic layer also comprises pneumatic channels that open on an outside surface of the pneumatic layer and an inside surface of the pneumatic layer. Where fluidic channels and pneumatic channels open onto the elastic layer opposite each other, diaphragm valves and other micromachines can be formed. Applying positive or negative pressure on a port in a pneumatic channel deflects the elastic layer and opens or closes valves in the fluidic channels to allow liquid to pass, or to pump liquid through a channel. This can occur when the chip is engaged with the pneumatic manifold so that the vias in the manifold are in pneumatic communication with ports in the pneumatic channels. The actuant can be air, but also can be a hydrolic fluid. The microfluidic device also comprises a cartridge.

The cartridge comprises compartments and wells that open on two surfaces of the reservoir. One side of the cartridge is engaged with the microfluidic chip. Ports in both parts are aligned with one another so as to be in fluidic communication. In this way, the chip can direct fluid in a various wells or compartments in the cartridge to other wells or compartments in the cartridge. The wells and compartments in the cartridge can have volumes in the mesofluidic or macrofluidic scale, that is between a microliter and tens of microliters, hundreds of microliters, milliliters, tens of milliliters or more. For example, the reservoir can comprise serpentine channels that can comprise reaction mixtures placed there by pumping liquid from wells in the cartridge that mate with ports on the chip, through pumps or valves in the microfluidic chip, out of the chip and into the compartments on the reservoir. For reaction mixtures that must be maintained at temperature, or undergo thermal cycling, the compartments holding these mixtures, e.g., the serpentine channels, can be positioned such that when the microfluidic device is loaded on the base, the compartments are in thermal contact with the heat controlling devices, e.g., the thermoelectric couplers.

The microfluidic device can be held in place by, for example, screws, clamps, etc. When pressed against the base, the microfluidic chip also engages the pneumatic manifold. When the pneumatic manifold is biased, a tight fit between the pneumatic manifold and the microfluidic chip, as well as between the reservoir and the thermal controllers, are maintained without the need for exact tolerances in loading the pneumatic manifold on the base.

As shown in FIG. 5 and FIG. 6, serpentine channels can be used as reaction chambers. The serpentine channels can be interfaced with temperature controlling devices, such as thermoelectric coolers. The temperature controlling device can be used to control the temperature of a component. It can utilize Peltier devices or heated or cooled liquids, gases, or other materials. The temperature controlling devices can be housed in a base, which may include a pneumatic floater, pneumatic inserts, and springs, described herein.

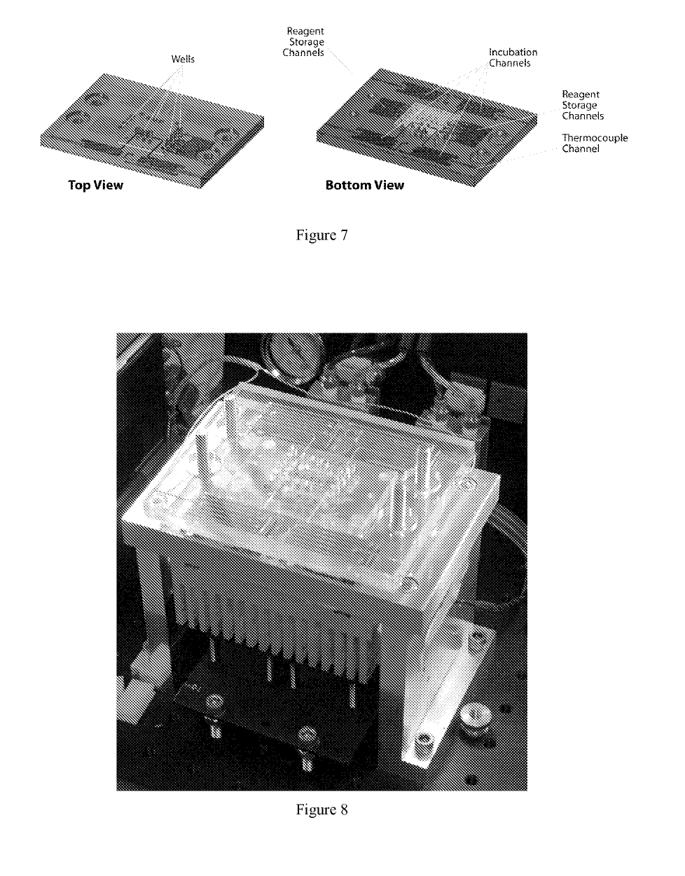

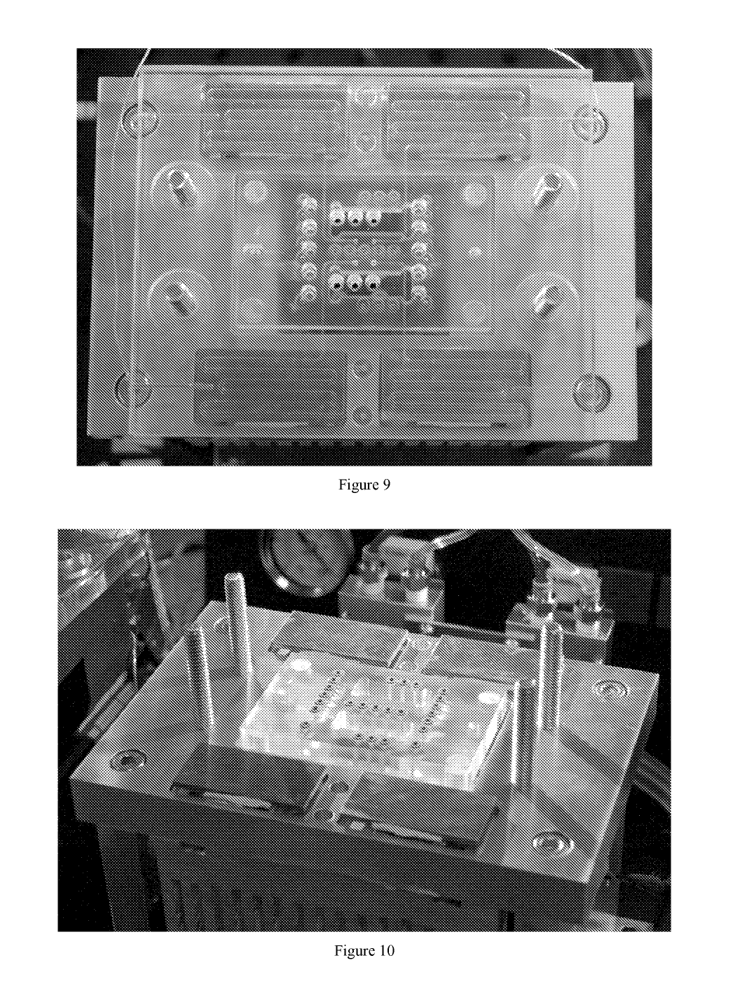

As shown in FIG. 5, the Fluidic Manifold can comprise two parts: Reservoir and Reservoir Bottom. The Reservoir can comprise a surface comprising channels or troughs. The Reservoir Bottom can serve to seal Reservoir channels and provides access holes (vias) to the attached chip. FIG. 7 shows top and bottom views of the assembled Fluidic Manifold. The chip can be attached to the bottom surface of the Fluidic Manifold with laser-cut pressure sensitive adhesive. The four Incubation Channels, fed from chip Out1 and Out2 wells on one (proximal) side, can also connect to additional pneumatic lines (or pneumatic channels) via Pneumatic Inserts (FIG. 5), on their other (distal) sides. The pneumatic inserts can provide for distal side connections that can allow air to escape or enter the incubation channels (which may be serpentine channels) as they are filled and emptied, respectively. Alternatively, they can be used to supply positive pressure or vacuum to the channels. Channel cross-sections can be 0.5 mm deep×1 mm wide, and channel length is approximately 200 mm (about 100 ul volume). In addition to Incubation Channels, the Fluidic Manifold can also contain Reagent Storage Channels. These can be filled from wells on the top surface of the Fluidic Manifold, and emptied into chip input/output wells. They can be designed to hold reagents at 4C for long periods of time, with minimal evaporation and condensation. Finally, four thermocouple channels can provide temperature measurement points for each of the four Incubation Channels. FIG. 8, FIG. 9, and FIG. 10 shows photographs of a system that lacks reagent Storage Channels. FIG. 8 shows a view of the Fluidic Manifold is resting on Pneumatic Floater (no chip). Heat sink and fan assembly can be visible beneath the Aluminum Manifold. FIG. 9 shows a top view of wells and incubation serpentine channels above copper heat spreader plates (on top of TECs) are shown. Two thermocouple wires leaving the assembly are visible. FIG. 10 shows an Aluminum Manifold and Pneumatic Floater. Copper heat spreading plates on top of TEC's, and Pneumatic Floater o-rings are visible.

A cartridge can be constructed of any material known to those skilled in the art. For example, the cartridge can be constructed of a plastic, glass, or metal. A plastic material may include any plastic known to those skilled in the art, such as polypropylene, polystyrene, polyethylene, polyethylene terephthalate, polyester, polyamide, poly(vinylchloride), polycarbonate, polyurethane, polyvinyldiene chloride, cyclic olefin copolymer (COC), or any combination thereof. The cartridge can be formed using any technique known to those skilled in the art, such as soft-lithography, hard-lithography, milling, embossing, ablating, drilling, etching, injection molding, or any combination thereof.

In some embodiments of the invention, a smooth fluidic manifold, or smooth components can be formed by injection molding. Additionally, adhesive and thermal bonding methods can be used for assembly. Use of smooth surfaces and/or certain types of materials, e.g., cyclic olefin copolymer, can reduce the formation of bubbles during heating steps. In some embodiments, materials that have low liquid and/or gas adsorption or absorption can be chosen. In other embodiments, materials that exhibit rigidity or low temperature dependent mechanical deformation can be chosen.

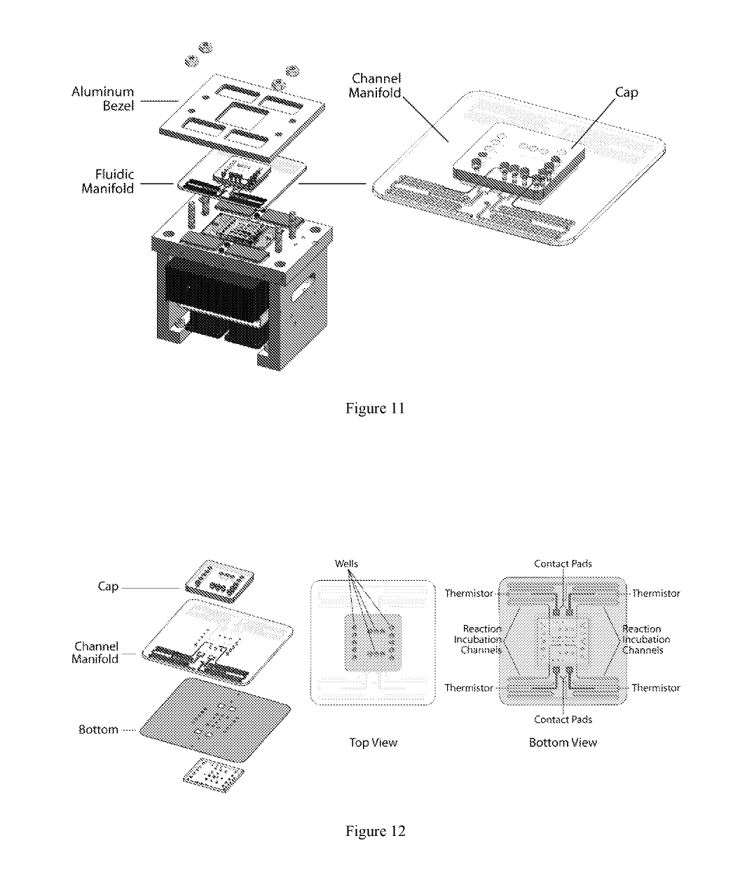

As shown in FIG. 11, the Fluidic Manifold can comprise three pieces: Cap, Channel Manifold, and Bottom (not visible). Injection molding fabrication can provide smooth channel surfaces. Adhesive and thermal bonding methods can be used for assembly. Preliminary evaluation of this system shows that it remains bubble-free up to approximately 95C. The left-hand portion of FIG. 11 shows a modified fluidic reservoir with aluminum bezel for enhanced mechanical stability. The right-hand portion of FIG. 11 shows a three piece fluidic manifold. Injection molded COC channel manifold and machined polycarbonate cap (carrying input/output wells) are visible.

FIG. 12 shows the structure of the Fluidic Manifold in more detail. Thermocouples can be replaced with small thermistors that may eliminate the requirement for direct wiring to the FTC100 temperature controller, and the associated flying leads. Instead, electrical connections can be made via contact pads on the bottom surface of the Fluidic Manifold and matching pogo pins in the Aluminum Manifold. The left-hand portion of FIG. 12 shows an exploded view of the three piece structure where the Bottom sealing the Channel Manifold is clearly visible. The middle and right-hand portion of FIG. 12 show top and bottom views. Wells in Cap, and features on the bottom surface of the Channel Manifold are clearly visible.

### B. Microfluidic Chips

In some instances, the microfluidic chip has diaphragm valves for the control of fluid flow. Microfluidic devices with diaphragm valves that control fluid flow have been described in U.S. Pat. No. 7,445,926, U.S. Patent Publication Nos. 2006/0073484, 2006/0073484, 2007/0248958, and 2008/0014576, and PCT Publication No. WO 2008/115626, which are hereby incorporated by reference in their entirety. The valves can be controlled by applying positive or negative pressure to a pneumatics layer of the microchip through a pneumatic manifold.

In one embodiment, the microchip is a “MOVe” chip. Such chips comprise three functional layers—a fluidics layer that comprises microfluidic channels; a pneumatics layer that comprises pneumatics channels and an actuation layer sandwiched between the two other layers. In certain embodiments, the fluidics layer is comprised of two layers. One layer can comprise grooves that provide the microfluidics channels, and vias, or holes that pass from the outside surface to a fluidics channel. A second layer can comprise vias that pass from a surface that is in contact with the actuation layer to the surface in contact with the pneumatic channels on the other layer. When contacted together, these two layers from a single fluidics layer that comprises internal channels and vias that open out to connect a channel with the fluidics manifold or in to connect a channel with the activation layer, to form a valve, chamber or other functional item. The actuation layer typically is formed of an elastomeric substance that can deform when vacuum or pressure is exerted on it. At points where the fluidic channels or pneumatic channels open onto or are otherwise in contact with the actuation layer, functional devices such as valves can be formed. Such a valve is depicted in cross section in FIG. 15. Both the fluidics layer and the pneumatics layer can comprise ports that connect channels to the outside surface as ports. Such ports can be adapted to engage fluidics manifolds, e.g., cartridges, or pneumatics manifolds.

As shown in FIG. 1, the microfluidic chip (103) can be interfaced with the cartridge (101). The microfluidic chip can have a chamber (105) with an opening that is mated to an opening (117) of the cartridge (101). The chamber can be used for a variety of purposes. For example, the chamber can be used as a reaction chamber, a mixing chamber, or a capture chamber. The chamber can be used to capture magnetic particles such as magnetic beads, paramagnetic beads, solid phase extraction material, monoliths, or chromatography matrices.

A magnetic component (109) can be positioned such that magnetic particles in the cartridge reservoir (107) and/or the microfluidic chamber (105) are captured against a surface of the microfluidic chamber (105). The magnetic component can generate a magnetic and/or electromagnetic field using a permanent magnet and/or an electromagnet. If a permanent magnet is used, the magnet can be actuated in one or more directions to bring the magnet into proximity of the microfluidic chip to apply a magnetic field to the microfluidic chamber. In some embodiments of the invention, the magnet is actuated in the direction (111) indicated in FIG. 1.

Alternatively, any of a variety of devices can be interfaced with the microfluidic chip. For example detectors, separation devices (e.g. gas chromatographs, capillary electrophoresis, mass spectrometers, etc), light sources, or temperature control devices can be positioned next to the microfluidic chip or used in conjunction with the microfluidic chip. These devices can allow for detection of analytes by detecting resistance, capacitance, light emission, or temperature. Alternatively, these devices can allow for light to be introduced to a region or area of the microfluidic chip.

A microfluidic device can be designed with multiple chambers that are configured for capture of magnetic particles. The multiple chambers and magnetic component can be arranged such that a magnetic field can be applied simultaneously to all chambers, or be applied to each or some chambers independent of other chambers. The arrangement of chambers and magnetic components can facilitate faster or more efficient recovery of magnetic particles. In particular, the arrangement can facilitate recovery of magnetic particles in multiple chambers.

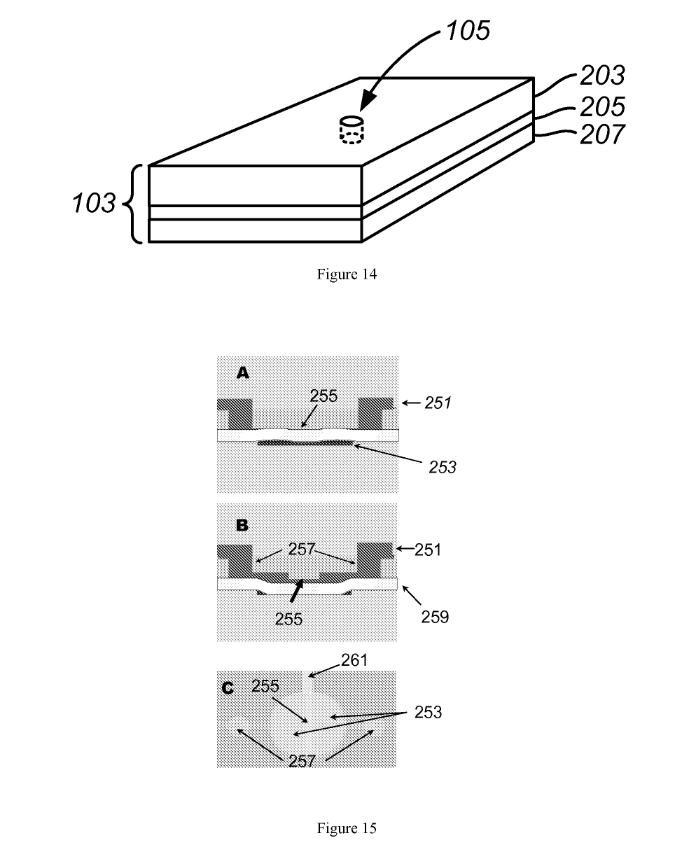

As shown in FIG. 14, the microfluidic chip (103) can be formed of a fluidics layer (203), an elastomeric layer (205), and a pneumatic layer (207). The fluidics layer can contain features such as a chamber (105), as well as channels, valves, and ports. The channels can be microfluidic channels used for the transfer of fluids between chambers and/or ports. The valves can be any type of valve used in microfluidic devices. In preferred embodiments of the invention, a valve includes a microscale on-chip valve (MOVe), also referred to as a microfluidic diaphragm valve herein. A series of three MOVes can form a MOVe pump. The MOVes and MOVe pumps can be actuated using pneumatics. Pneumatic sources can be internal or external to the microfluidic chip.

A MOVe diaphragm valve is shown in FIG. 15. A cross-sectional view of a closed MOVe is shown in FIG. 15A. A cross-sectional view of an open MOVe is shown in FIG. 15B. FIG. 15C shows a top-down view of the MOVe. A channel (251) that originates from a fluidic layer can interface with an elastomeric layer by one or more vias (257). The channel can have one or more seats (255) to obstruct flow through the channel when the elastomeric layer (259) is in contact with the seat (255). The elastomeric layer can either be normally in contact with the seat, or normally not in contact with the seat. Application of positive or negative pressure through a pneumatic line (261) to increase or decrease the pressure in pneumatic chambers (253) relative to the fluidic channel (251) can deform the elastomeric layer, such that the elastomeric layer is pushed against the seat or pulled away from the seat. In some embodiments of the invention, a MOVe does not have a seat, and fluid flow through the fluidic channel is not obstructed under application of positive or negative pressure. The vacuum that can be applied include extremely high vacuum, medium vacuum, low vacuum, house vacuum, and pressures such as 5 psi, 10 psi, 15 psi, 25 psi, 30 psi, 40 psi, 45 psi, and 50 psi.

Three MOVes in series can form a pump through the use of a first MOVe as an inlet valve, a second MOVe as a pumping valve, and a third MOVe as an outlet valve. Fluid can be moved through the series of MOVes by sequential opening and closing of the MOVes. For a fluid being supplied to an inlet valve, an exemplary sequence can include, starting from a state where all three MOVes are closed, (a) opening the inlet valve, (b) opening the pumping valve, (c) closing the inlet valve and opening the outlet valve, (d) closing the pumping valve, and (e) closing the outlet valve.

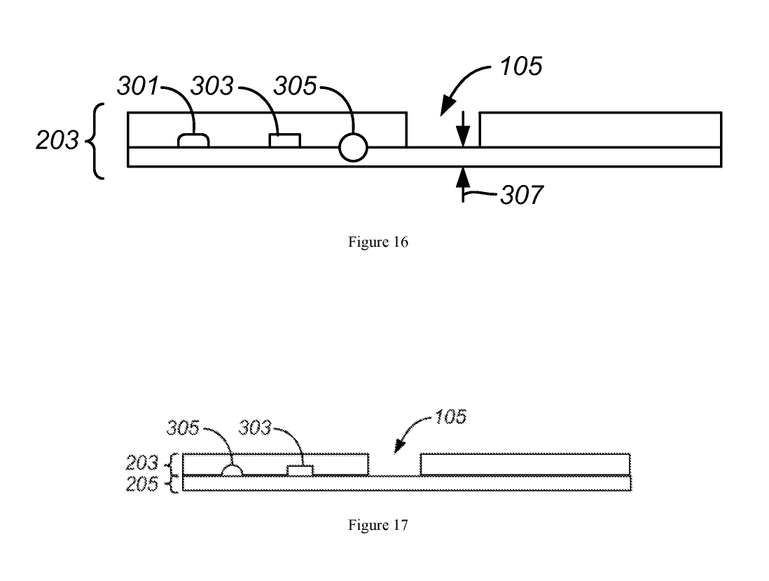

The fluidic layer (203) can be constructed of one or more layers of material. As shown in FIG. 16, the fluidic layer (203) can be constructed of two layers of material. Channels (301, 303, 305) can be formed at the interface between the two layers of material, and a chamber (105) can be formed by complete removal of a portion of one layer of material. The channels can have any shape, e.g., rounded and on one side (301), rectangular (303), or circular (305). The channel can be formed by recesses in only one layer (301, 303) or by recesses in both layers (305). The channels and chambers can be connected by fluidic channels that traverse the channels and chambers shown. Multidimensional microchips are also within the scope of the instant invention where fluidic channels and connections are made between multiple fluidic layers.

The thickness (307) of the second layer of material can be of any thickness. In some embodiments of the invention, the second layer has a thickness that minimizes reduction of a magnetic field in the chamber (105) that is applied across the second layer from an external magnetic component or minimizes reductions in heat transfer

As shown in FIG. 17, the fluidic layer (203) can be constructed of a single layer of material. The single layer is then interfaced with an elastomeric layer, such that channels (305, 303) and chambers (305) are formed between the fluidic layer and the elastomeric layer (205).

The microfluidic chip can be constructed from any material known to those skilled in the art. In some embodiments of the invention, the fluidics and pneumatic layer are constructed from glass and the elastomeric layer is formed from PDMS. In alternative embodiments, the elastomer can be replaced by a thin membrane of deformable material such as Teflon, silicon or other membrane. The features of the fluidics and pneumatic layer can be formed using any microfabrication technique known to those skilled in the art, such as patterning, etching, milling, molding, laser ablation, substrate deposition, chemical vapor deposition, or any combination thereof.

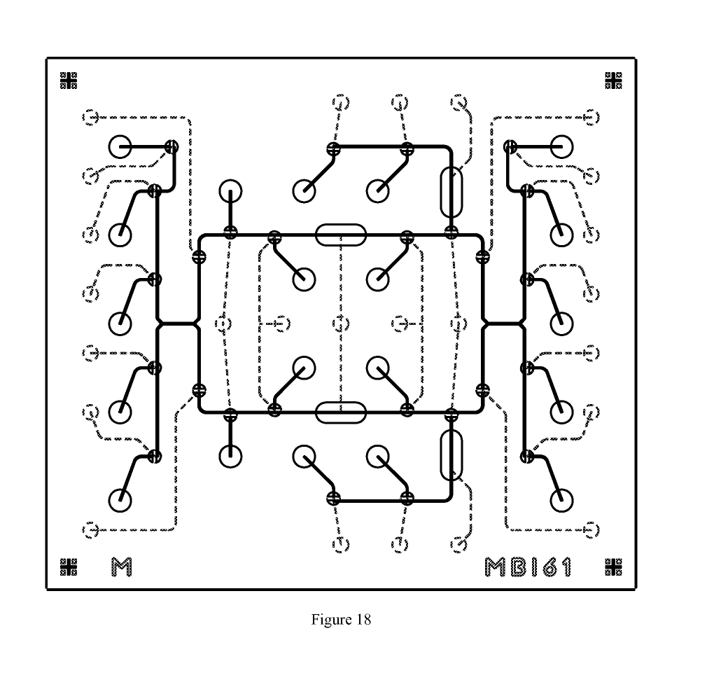

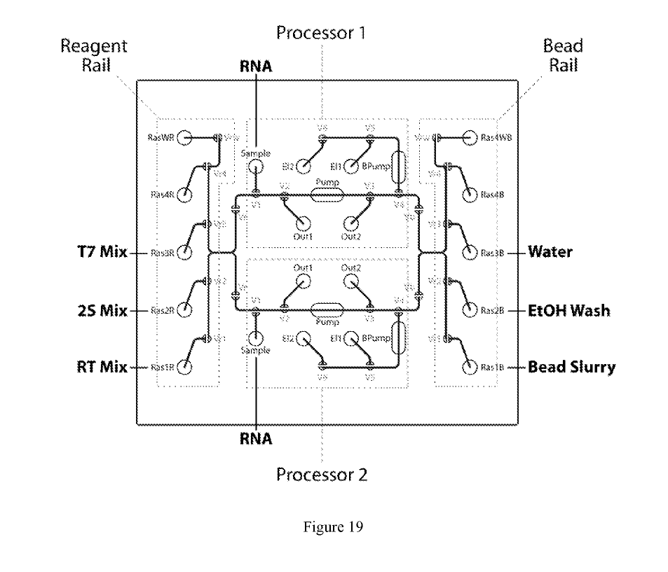

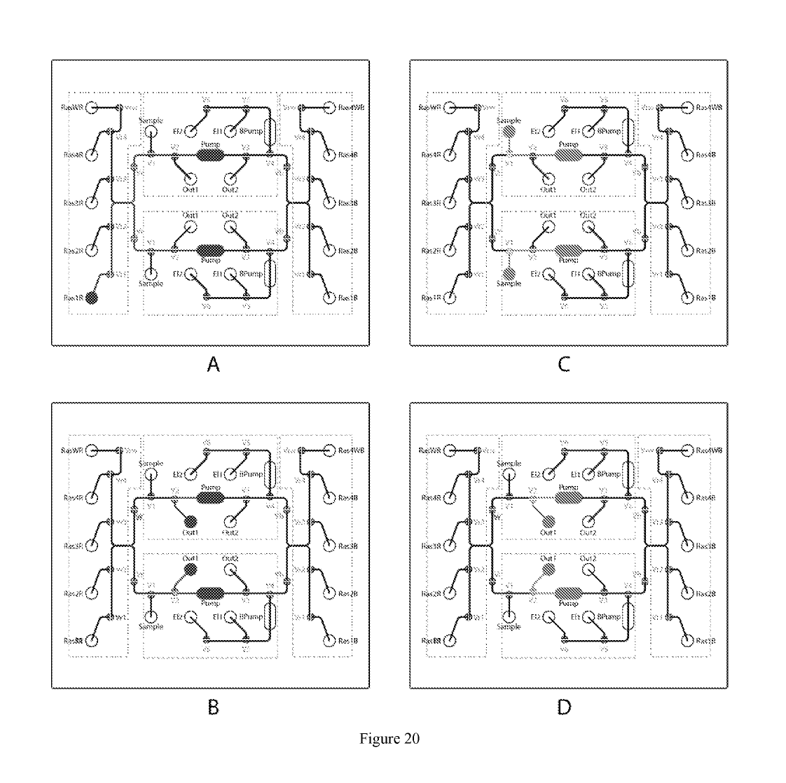

FIG. 18 and FIG. 19 show diagrams of a microfluidic chip. The microfluidic chip is a three layer chip comprising a glass-PDMS-glass sandwich. Referring to FIG. 18, fluidic features can be etched and drilled into the top glass layer, and pneumatic features can be etched and drilled into the bottom glass layer. The dashed lines can be pneumatic layer features and the solid line can be fluidic layer features. Referring to FIG. 19, the chip has four sections: Reagent Rail, Bead Rail, Processor 1, and Processor 2. The two rails and the two processors can be identical (mirrored) geometries. In some embodiments, the chip is configured so that either the Reagent or Bead Rails feed both processors. Rail access to the processors can be controlled by valves Vr and Vb. During reagent processing (enzyme reactions), Vr opens and Vb may be closed. During bead-based clean-up, the reverse applies, that is, Vr may be closed and Vb may be open. Each rail can access four different input wells and one waste well, via valves Vr1-4, and VrW, respectively. Each processor can have a sample input well (Sample), two output intermediate processing wells (Out1, Out2), and two eluate output wells E11 and E12. Processors can also have two pumps (Pump, BPump), both of which can actuate fluid transfer. Pump can be used for routine pumping operations while BPump can be used mainly as a bead collection reservoir. The fabrication parameters for the microfluidic chip can be 75 um channel depth, 250 um (final) fluid channel width. As described below, the pneumatic layer of BPump can be milled-out to a depth of 500 um. Pump and BPump pump stroke volumes can be approximately 0.5 ul and 1 ul, respectively.

In some embodiments, the chip functions in conjunction with pneumatic and fluidic manifolds. The pneumatic manifold can mate with pneumatic wells on the bottom surface of the chip, connecting them to either vacuum or positive pressure sources through computer-controlled solenoid valves. The pneumatic manifold can also position magnets underneath BPumps. The fluidic manifold can mate input/output ports to the fluidic wells on the top surface of the chip. Wells Out1 and Out2, however can be used for intermediate processing, and these can connect instead to reaction mixing/incubation reservoirs in the fluidic manifold.

The valves and pumps can be used to move materials within the components described herein, including a fluidic manifold, a microfluidic chips, and a pneumatic manifold. FIG. 20 illustrates how a reaction comprising Reagent 1 and Sample may be assembled in Out1 by 4-cycle pumping. Assume all valves may be initially closed. In Cycle A, valves Vr1 and Vr can open, allowing Pump to draw Reagent 1 from well Ras1R with a down-stroke (vacuum applied to Pump). Reagent in Ras1R can be drawn into Pump. In Cycle B, valves Vr1 and Vr can be closed and valve V2 can be open, allowing Pump to expel its contents into the Out1 reservoir with an up-stroke (positive pressure applied to Pump). Reagent in Pump can be expelled into Out1 reservoir. In Cycle C, RNA in Sample can be drawn into Pump. In Cycle D, RNA can be expelled into Out1 reservoir. Cycles C and D, operate analogously; the only difference is that Pump is filled from Sample in cycle C. Cycles A, B, C, D are repeated until a sufficient volume has been pushed into Out1. Note that the Reagent 1-to-Sample mixing ratio can be determined by the ratio of cycles AB:CD. In the process described above, the mixing ratio is 1:1, but it can in principle be any integral ratio. Finally, similar procedures can be used to mix any of the reagents (Ras1-4) with Sample, by substituting the appropriate valve for Vr1. Mixing can be promoted by the generation of multiple component interfaces, and by turbulence associated with pumping and fluid flow in chip wells. Mixing can occur due convection and diffusion at multiple interfaces due to sequential layering of reagent and RNA in Out1 reservoir.

### C. Pneumatic Manifolds

A pneumatic manifold can be used to mate the pneumatic lines of a microfluidic chip to external pressure sources. The pneumatic manifold can have ports that align with ports on the pneumatics layer of the microfluidic chip and ports that can be connected to tubing that connect to the external pressure sources. The ports can be connected by one or more channels that allow for fluid communication of a liquid or gas, or other material between the ports.

The pneumatic manifold can be interfaced with the microfluidic chip on any surface of the chip. The pneumatic manifold can be on the same or different side of the microfluidic chip as the cartridge. As shown in FIG. 1, a pneumatic manifold (113) can be placed on a surface of the microfluidic chip opposite to the cartridge. As well, the pneumatic manifold can be designed such that it only occupies a portion of the surface of microfluidic chip. The positioning, design, and/or shape of the pneumatic manifold can allow access of other components to the microfluidic chip. The pneumatic manifold can have a cut-out or annular space that allows other components to be positioned adjacent or proximal to the microfluidic chip. This can allow, for example, a magnetic component (109) to be placed in proximity of a chamber within the microfluidic chip.

A pneumatic manifold, or any other component described herein, can be constructed of any material known to those skilled in the art. For example, the cartridge can be constructed of a plastic, glass, or metal. Metals can include aluminum, copper, gold, stainless steel, iron, bronze, or any allow thereof. The materials can be highly conductive materials. For example, a material can have a high thermal, electrical, or optical conductance. A plastic material includes any plastic known to those skilled in the art, such as polypropylene, polystyrene, polyethylene, polyethylene terephthalate, polyester, polyamide, poly(vinylchloride), polycarbonate, polyurethane, polyvinyldiene chloride, cyclic olefin copolymer, or any combination thereof. The pneumatic manifold can be formed using any technique known to those skilled in the art, such as soft-lithography, conventional lithography, milling, molding, drilling, etching, or any combination thereof.

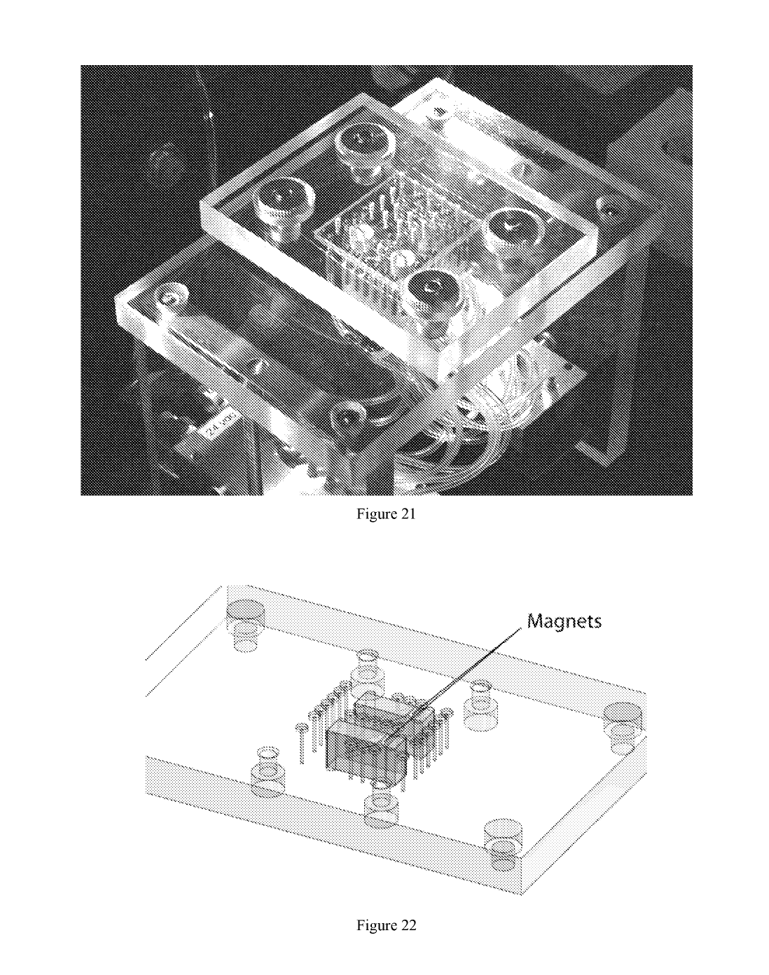

FIG. 13 shows the overall organization of a system. A microfluidic chip can be sandwiched between polycarbonate (PC) Pneumatic and Fluidic Manifolds. In this system, pipette tips (not shown) can be inserted into the top of the fluidic manifold and can serve both as fluid input/output ports, and as incubation reservoirs. The aluminum TEC-Tip Manifold can surround the four pipette tips that serve as incubation reservoirs (for Out1 and Out2) and controls their temperature with attached Peltier thermoelectric coolers (TECs). Note that although FIG. 13 shows two TEC Stacks, four TEC Stacks can be used. The other two TEC Stacks can be attached in similar positions, on the opposite face of the Tip Manifold. FIG. 21 shows a photograph of the system without pipette tips or TEC-Tip Manifold. The system can be assembled with bolts and thumb screws that serve to align the two manifolds and compress o-rings carried on the Pneumatic Manifold.

A Pneumatic Manifold can make a connection to pneumatic wells along the chip bottom surface. Gas-tight connections can be established with o-rings, glued to recesses on the top surface of the manifold. Each pneumatic chip well can then be connected, via through-holes in the manifold with glued-in metal canula (not shown), to a pneumatic line originating at a two-position solenoid valve. As described below, computer-controlled solenoid valves may select either vacuum or positive pressure for each pneumatic well. The Pneumatic Manifold can also carry two magnets interfacing with chip BPumps. FIG. 22 shows a Pneumatic Manifold with cutouts for (Delrin) Magnet Cradles carrying angled small bar magnets. The angled position of the magnets can be chosen to focus the magnet field along the centerlines of the BPumps.

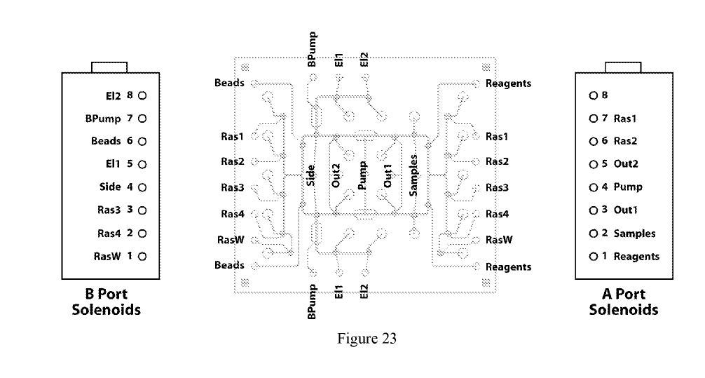

Pneumatic routing for control of valves and pumps is shown in FIG. 23. Solenoid blocks each carry eight two-position solenoids which route either vacuum or positive pressure to outputs 1-8 on each block. Solenoid outputs are connected to the indicated chip wells with tubing. Solenoid labels are used to address individual solenoids in DevLink code.Note that Reagent and Bead Rail valves can be identically labeled, indicating that these valves are operated simultaneously. Alternatively, these valves may be operated independently. Within the chip, however, access to the processors can be gated by two pairs of valves labeled Reagents and Beads. Other valves and pumps which share the same label may operate simultaneously, without differentiation. Thus, the two chip processors may operate simultaneously and in parallel. Alternatively, the two chip processors can be configured to operate independently. Alternative configurations can be designed by choosing appropriate valve, channel, pneumatic, and control configurations.

Vacuum and positive pressure can be generated by a small double-headed Hargraves diaphragm pump. These pumps can be capable of generating vacuums of about 21 in. Hg, and positive pressures of up to about 25 PSI. Chips can be run at maximum vacuum and 15 PSI positive pressure. For transport of viscous materials, increasing pump membrane transition times can improve pumping performance. Pump transition times can be adjusted by inserting an adjustable orifice in the pneumatic line driving chip Pumps. A range of precision orifices can be purchased from Bird Precision (http://birdprecision.com).

In addition, and as discussed more fully below, BPump performance can be improved with higher vacuum levels (28 in. Hg), which can be generated with a KNF UN86 pump connected in series with the vacuum side of the Hargraves pump.

In some embodiments, a base can include a support structure, one or more pneumatic manifolds, which may be pneumatic floaters, one or more pneumatic inserts, and one or more temperature controlling devices. An exploded view of a system is shown in FIG. 5. The system includes a fluidic manifold (reservoir & reservoir bottom), microfluidic chip (061 chip), floater, inserts, thermoelectric coolers (TECs), and a support structure (aluminum manifold) is shown in FIG. 5. An assembled view of FIG. 5 is shown in FIG. 6.

The heat sinking capacity for the TECs can be increased by mounting them directly on a large aluminum manifold which serves as the base plate of the system. The upper (working) surfaces of the TECs touch the Reservoir Bottom, directly beneath the serpentine incubation channels, when the system is fully assembled. Moderate force can be exerted on this interface by tightening four thumb screws (not shown).

Another feature is the use of a small Pneumatic Floater to carry magnets and provide a pneumatic interface to the bottom of the chip. The Pneumatic Floater can serve the same purpose as the previous pneumatic manifold, but it rides on springs mounted onto the Aluminum Manifold. The spring force can serve to compress the o-rings that provide gas-tight connections to the bottom surface of the chip.

The use of springs for mounting or compressing of the pneumatic floater to the microchip can facilitate assembly of the system can reduce the need for production of high-tolerance components. In the case of the system utilizing a support structure that has mounted to it the thermoelectric cooler and the pneumatic floater, the thermoelectric cooler must interface with the cartridge and the pneumatic floater must interface with the microfluidic chip. The chip is also interfaced with the cartridge. Because the chip, the cartridge, the support structure, the thermoelectric coolers, and the pneumatic floaters may each vary in thickness from device to device, springs can allow for proper interfacing of both pairs of components without the need to produce each component in high tolerance or high accuracy or precision. This can reduce the time for manufacture of each component and the time for assembly of the system. The time for manufacture of each component can be up to about, less than about, or about 0.1, 0.25, 0.5, 0.75, 1, 2, 3, 4, 5, 6, 8, 10, 12, 15, 24, 36, or 48 hours. The time for assembly of the system can up to about, less than about, or about 0.01, 0.05, 0.1, 0.25, 0.5, 0.75, 1, 2, 3, 4, 5, 6, 8, 10, 12, 15, or 24 hours.

### II. Applications

### A. mRNA Amplification

Gene expression microarrays can monitor cellular messenger RNA (mRNA) levels. Messenger RNA can constitute typically only 1-3% of cellular total cellular RNA. The vast majority of cellular RNA can be ribosomal RNA (rRNA), and these molecules may interfere with mRNA analysis by competing with mRNA for hybrization to microarray probes. Any mRNA amplification method can be performed by the devices described herein, for example LAMP, TLAD (Eberwine), and MDA. In some embodiments of the invention, isothermal mRNA amplification methods can be performed using the devices described herein. In other embodiments, thermal cycling can be performed to accomplish PCR or cycle sequencing. Messenger RNA amplification procedures can specifically target polyadenylated (polyA+) mRNA for amplification, virtually eliminating rRNA interference. This characteristic can remove any need to pre-purify mRNA from total RNA, which can be an inefficient, time-consuming, and expensive process. In addition, by greatly increasing the amount of target RNA (that is, amplified mRNA or aRNA) available for microarray hybridization, mRNA amplification can allow much smaller samples (fewer numbers of cells) to be analyzed. This is, of course, generally helpful because the relatively large amount of target RNA required for microarray analysis (typically 15 ug) can be frequently difficult to obtain. Moreover, it can be relevant for many important clinical diagnostic applications analyzing samples containing few cells, for example, samples derived from fine needle aspirates (FNA) or laser capture microdissection (LCM).

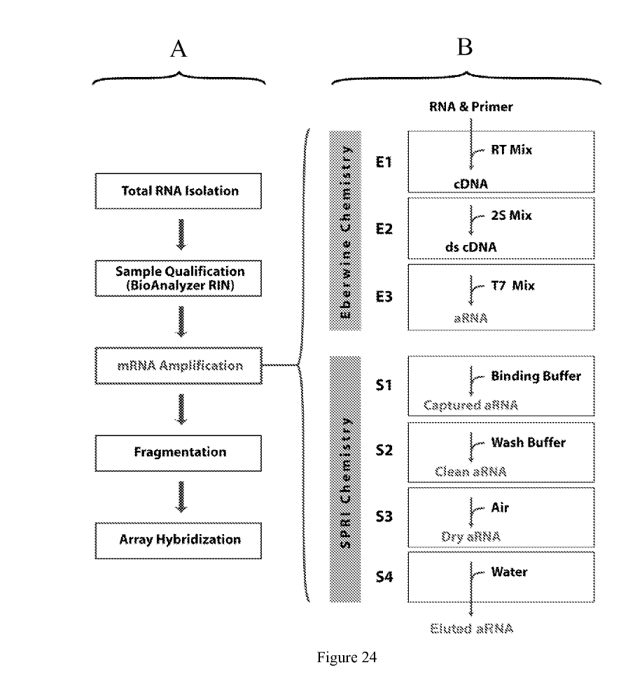

As shown in FIG. 24A, the overall microarray sample prep process can begin with total cellular RNA, which may be characterized by microchip capillary electrophoresis with an Agilent Bioanalyzer to quantitate 28S/18S ratios and to generate a RNA Integrity Number (RIN). If the total RNA is of suffficient quality, the mRNA can be amplified, and the amplified RNA (aRNA) can then be fragmented and hybridized to microarrays. The methods, devices, and systems described herein can allow for execution of the mRNA amplification process on a microchip-based system. The mRNA amplification chemistry can utilize Eberwine mRNA amplification, as implemented in the Ambion Message Amp III kit. This process is outlined in FIG. 24B, which shows that the amplification process can comprise two multistep components: Eberwine enzyme reactions and Solid Phase Reversible Immobilization (SPRI) aRNA clean-up. These processes are discussed in detail herein.

Any process that alters relative mRNA abundance levels may potentially interfere with accurate gene expression profiling. An important aspect of the Eberwine amplification procedure is that it can employ a linear amplification reaction that can be less prone to bias mRNA populations than exponential amplification methods such as PCR.

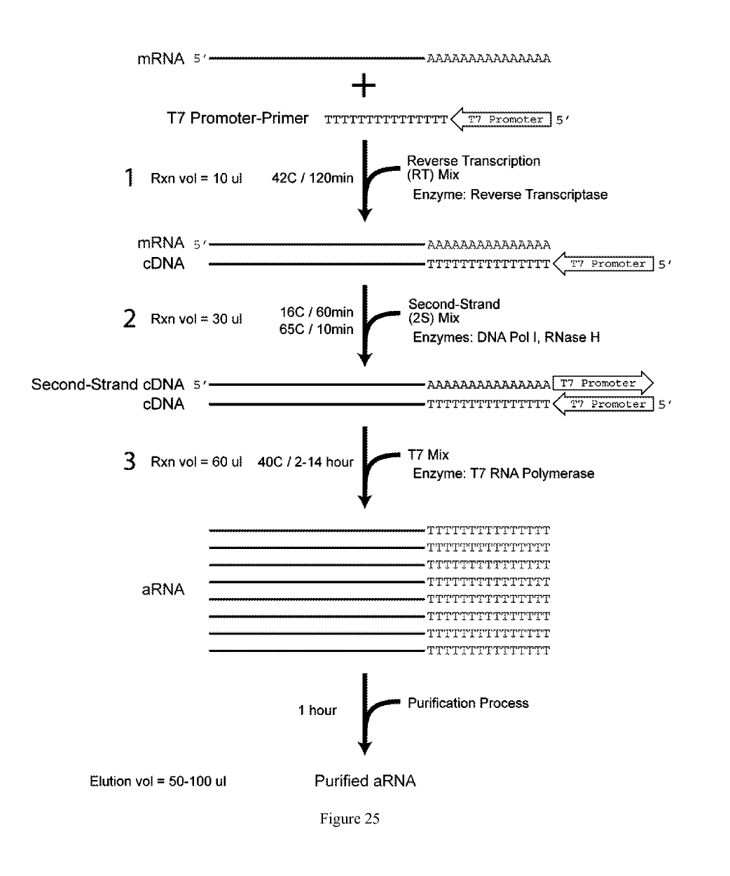

The original Eberwine protocol has been streamlined and simplified by commercial vendors such as Ambion. As shown in FIG. 25, the Ambion procedure comprises three binary (two component) additions followed by an RNA purification process. Each binary addition can be followed by incubation(s) at specific temperatures, as indicated in FIG. 25. The initial reverse transcription (RT) reaction can have three inputs (primer, total RNA, and reverse transcriptase [RT] Mix); however, total RNA and primer can conveniently be premixed. Typical volumes for this first reaction can be 5 ul RNA+Primer 5 ul RT Mix. Only mRNA hybridizes to the oligo dT primer and is transcribed into DNA. The second-strand reaction can be initiated by addition of 20 ul of a Second-Strand Mix, and the final T7 amplification reaction can be initiated by addition of 30 ul of a T7 Mix. Synthesized RNA can be labeled at this stage by incorporation of biotin-labeled ribonucleotides. Mixes contain buffers (Tris), monovalent and divalent salts (KCl, NaCl, MgCl₂), nucleotides, and DTT, along with enzymes as indicated. Typically, enzymes can be premixed with concentrated mixes just prior to use. The process can be implemented using three sequential enzyme reactions, including reverse transcription, DNA polymerization, and RNA polymerization. The three steps can be implemented without intermediate clean-up steps. A heat-kill step can be included after the DNA polymerization or second-strand synthesis (step 2).

After synthesis, aRNA can be purified to remove enzymes, buffers, salts, unincorporated nucleotides, pyrophosphate, etc. Purification can rely on commercial kits exploiting the association of aRNA with silica membranes or beads in the presence of chaotropic salts such as guanidinium hydrochloride (GuHCl) or thiocyanate (GuSCN). After binding, the silica is washed with 70% ethanol (EtOH), dried, and aRNA is eluted with water.

As described above, the Eberwine mRNA amplification procedure can be a cascade of three binary additions. To execute the Eberwine sequence, assume that Ras1R contains RT Mix, Ras2R contains second-strand synthesis (2S) Mix, and Ras3R contains T7 Mix, as shown in FIG. 19. As indicated in FIG. 25 for Message Amp III, a 2× volume of 2S Mix will be added to the RT reaction, and a 1× volume of T7 Mix will be added to the 2S reaction. This requires a 2:1 pumping ratio (AB:CD) for the 2S Mix addition, and a 1:1 ratio for the T7 Mix addition.

Assume that 4-Cycle pumping assembled the first (RT) reaction with a 1:1 mixture of total RNA from Sample and 2× RT Mix from Ras1R in the Out1 reservoir. After an appropriate incubation period, the second-strand reaction may be assembled in the Out2 reservoir by drawing from Out1 (rather than from Sample), and drawing from Ras2R (rather than from Ras1R). In other words, in cycle A, Vr2 is opened rather than Vr1; in cycle B, V3 is opened rather than V2; in cycle C, V2 is opened rather than V1; and in cycle D, V3 is opened instead of V2. Note that to obtain the required 2:1 mixing ratio, for every cycle drawing from Out1, two cycles will draw from Ras2R.

After another appropriate incubation period, the third (T7) reaction may be assembled in the reservoir connected to Out1 with a similar process (drawing from Ras3R and Out2, 1:1 ratio). Thus the final T7 reaction will reside in the Out1 reservoir. After an appropriate incubation period, aRNA will be ready for purification.

Each of these steps can be carried out on the devices described herein. For example, reagents and sample can be supplied through ports in the cartridge and then delivered to the microfluidic chip. The on-chip valves can be used to pump the reagents and samples to chambers and reservoirs in the cartridge and the microfluidic chip through channels. Temperature control can be accomplished using internal or external heating and cooling devices. The reaction products can be moved to product outlet ports of the cartridge for further handling. Alternatively, the reaction products can be purified or separated using the devices of the invention.

### B. Separation and Cleanup

A variety of separations can be performed using the devices described herein. These separations include chromatographic, affinity, electrostatic, hydrophobic, ion-exchange, magnetic, drag-based, and density-based separations. In some embodiments of the invention, affinity or ion-exchange interactions are utilized to bind materials to solid-phase materials, such as beads. The beads can be separated from fluid solutions using any method known to those skilled in the art.

In some embodiments, separation and cleanup can include solid phase reversible immobilization (SPRI). SPRI can utilize a variety of chemistries, including guanidinium-based purification chemistries and magnetic bead-based chemistry. Guanidinium buffers can be toxic, near-saturated solutions prone to crystal particulate formation. Guanidinium buffers can promote binding to silica (glass) surfaces. Other chemistries that can be utilized include PEG/salt-driven association of nucleic acids with magnetic beads that can be covered with carboxylated polymers (deAngelis et al., Nucl. Acids Res. 23, 4742). Typically, beads in 2× buffer (20% PEG8000, 2.5M NaCl) are combined with RNA in a 1:1 ratio. After a brief incubation period, RNA-bead complexes are captured with a magnet, the beads are washed with 70% EtOH, briefly dried, and RNA is eluted in a small volume of water. Carboxylated polymer double shell magnetic beads (SpeedBeads) are available from Seradyne (http://www.seradyn.com/micro/particle-overview.aspx).

Magnetic separation can be used to capture and concentrate materials in a single step using a mechanistically simplified format that employs paramagnetic beads and a magnetic field. The beads can be used to capture, concentrate, and then purify specific target antigens, proteins, carbohydrates, toxins, nucleic acids, cells, viruses, and spores. The beads can have a specific affinity reagent, typically an antibody, aptamer, or DNA that binds to a target. Alternatively electrostatic or ion-pairing or salt-bridge interactions can bind to a target. The beads can be paramagnetic beads that are only magnetic in the presence of an external magnetic field. Alternatively, the beads can contain permanent magnets. The beads can be added to complex samples such as aerosols, liquids, bodily fluids, extracts, or food. After (or before) binding of a target material, such as DNA, the bead can be captured by application of a magnetic field. Unbound or loosely bound material is removed by washing with compatible buffers, which purifies the target from other, unwanted materials in the original sample. Beads can be small (nm to um) and can bind high amounts of target. When the beads are concentrated by magnetic force they can form bead beds of just nL-μL volumes, thus concentrating the target at the same time it is purified. The purified and concentrated targets can be conveniently transported, denatured, lysed or analyzed while on-bead, or eluted off the bead for further sample preparation, or analysis.

Separations are widely used for many applications including the detection of microorganisms in food, bodily fluids, and other matrices. Paramagnetic beads can be mixed and manipulated easily, and are adaptable to microscale and microfluidic applications. This technology provides an excellent solution to the macroscale-to-microscale interface: beads can purify samples at the macroscale and then concentrate to the nanoscale (100's of nL) for introduction into microfluidic or nanofluidic platforms. Magnetic separations can be used as an upstream purification step before real-time PCR, electrochemiluminescence, magnetic force discrimination, magnetophoretic, capillary electrophoresis, field-flow separations, or other separation methods well known to one skilled in the art.

The devices of the invention can accommodate the use of magnetic beads. For example, beads or bead slurry can be supplied to a port of a cartridge. The beads can be mixed or suspended in solution within the cartridge using pumping, magnetic fields, or external mixers. The beads can then be pumped to desired chambers or reservoirs within the microfluidic device or cartridge. Beads can be captured within a chamber using a magnetic field. Beads in a solution can be captured as the solution travels through the magnetic field, or beads can be captured in a stagnant solution.

RNA purification can involve operation of the Bead Rail rather than the Reagent Rail. Thus, during this phase of chip operation, valve Vr will remain closed and Vb will open. As described above, 4-Cycle pumping can be used to mix 2× Bead Slurry from Ras1B (FIG. 19) with aRNA from the Out 1 reservoir, into the Out2 reservoir. The next step, after a brief incubation period, is collection of RNA—bead complexes in BPump. To do this, assume first that the BPump membrane remains pulled down into the 500 um deep pneumatic cavity. Then, 2-Cycle pumping (analogous to cycles AB or CD in FIG. 20) can be used to pump the bead binding mixture from the Out2 reservoir, through BPump, and out to E11. RNA-bead complexes are captured in the BPump, as they are pulled down out of the main flow path by the magnet positioned immediately beneath the chip (in the pneumatic manifold). After capture, beads are washed with 100% EtOH, and dried by (2-Cycle) air pumping from Ras4B (which is empty).

RNA elution can rely on “disruptive mixing” of beads (initially captured in the BPump) and water from Ras3B. This cam be accomplished through the use of the BPump membrane to (2-Cycle) pump water from Ras3B to the Out1 reservoir. The packed bead bed, deposited on the BPump membrane, can be rapidly disrupted and mixed with water as the BPump membrane reciprocates. Finally, beads and released aRNA can be pumped back through BPump to E12. Beads are recaptured in BPump, and aRNA (in water) ends up in E12.

### III. Examples

### A. Script for RNA Purification

Scripts can be written to operate and/or automate the systems, devices, and methods described herein. The following is an example of a script for performing RNA purification.

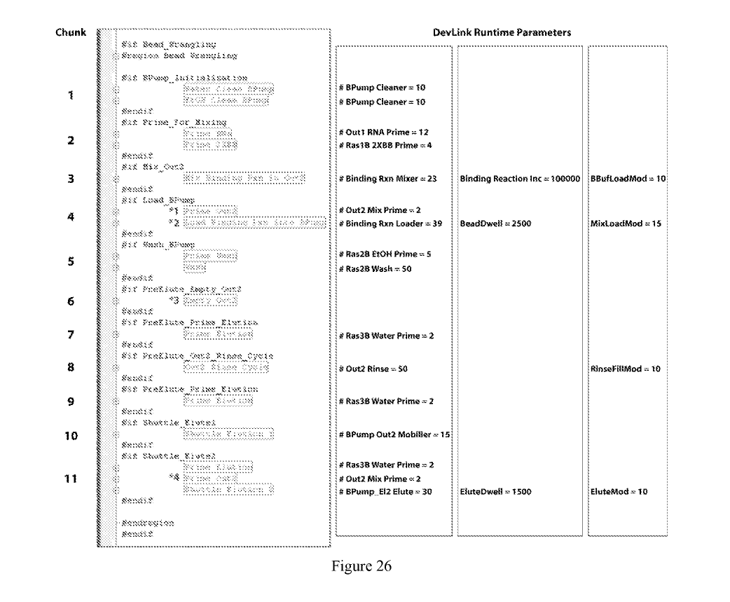

As shown in FIG. 26 (left), the script is organized into 11 code chunks. Each chunk has associated run-time parameters which are shown on the right. Four points where RNA purification losses may occur are indicated in red. Chunks are discussed below. Unless otherwise noted, pump cycles are executed by chip pumps (Pump). Chip pumps move 0.5 ul/stroke and BPumps move 1 ul/stroke.

1. BPump_Initialization. BPump chambers are cleaned as the BPump membrane pumps water and then EtOH (# BPump Cleaner=10). BPumps are left filled with EtOH, bubble-free, and ready to accept Bead-RNA mix later in the script.

2. Prime_For_Mixing. RNA (Out1) and 2XBB (Ras1B) are primed (# Out1 RNA Prime=12 and # Ras1B 2XBB Prime=4, respectively). Priming removes any air in manifold dead volumes, and assures that subsequent mixing will be accurate.

3. Mix_Out2. Twenty cycles of eight-step pumping mix RNA (10 ul) and 2XBB (10 ul) in Out2 (total volume 20 ul). Note that the #Binding Rxn Mixer=23 cycles. This is because three cycles are used to re-prime 2XBB from Ras1B at 10 cycle intervals (at cycles 0, 10, and 20) as specified by BBufLoadMod=10. A 100 sec binding reaction incubation is programmed (Binding Reaction Inc=100000), after mixing is completed.

4. Load_BPump. To minimize introduction of air bubbles into BPumps during transfer of the RNA-bead binding reaction to BPumps, Out2 is first primed to remove any accumulated air (# Out2 Mix Prime=2). This is a (first) programmed loss of RNA, as up to 1 ul out of 20 ul (5%) is deliberately lost to priming. After Out2 priming, the binding reaction is pumped through BPumps to waste ports W. As the mixture traverses BPumps, RNA-bead complex is captured by magnets positioned underneath BPumps. To maximize bead capture, an additional dwell time is introduced into each pump cycle (BeadDwell=2500). Note that # Binding Rxn Loader=39 intentionally leaves 0.5 ul (second programmed loss, 2.5%) behind in Out2, again to avoid introduction of air bubbles into BPumps. Finally, during transfer, additional (third programmed) losses of 3*2.5% are incurred by periodic Out2 re-priming at cycles 0, 15, and 30 (MixLoadMod=15). Total programmed maximum losses are therefore 5+2.5+7.5=15% at this point.

5. Wash_BPump. After Wash priming (Ras2B EtOH Prime32 5), the accumulated RNA-bead bed is washed with 100% EtOH (Ras2B Wash=50). Note that only about 12.5 ul 100% EtOH is loaded into the Ras2B pipette tip, as the rest of the cycles are reserved for pumping of air to dry the washed bead bed.

6. PreElute_Empty_Out2. Since Out2 will next be used to hold elution material, it must be cleaned prior to use. The first step in this process is removal of any remaining RNA-bead binding mix from Out2. Ten pump cycles are hardwired into the script at this point.

7. PreElute_Prime_Elution. Elution (water) is primed (Ras3B Water Prime=2) to eliminate any air bubbles and to wash processor channels.

8. PreElute_Out2_Rinse_Cycle. This step fills Out2 with 25 ul (# Out2 Rinse=50) of water and then empties it.

9. PreElute_Prime_Elution. Elution (water) is primed (Ras3B Water Prime=2) to eliminate any air bubbles and to wash processor channels.

10. Shuttle_Elute_{—}1. The washed and dried bead bed is disrupted and mobilized into elution water by BPump membrane pumping. The number of BPump cycles, therefore, determines the elution volume which has been set to 15 ul (BPump Out2 Mobilizer=15) in this script. The bead/RNA/water mixture is pumped into Out2.

11. Shuttle_Elute_{—}2. In this final step, beads and eluted RNA are separated by re-collection of beads in BPumps. In the first substep, processor channels are re-primed with water (Ras3B Water Prime=2) to remove any air bubbles or stray beads. Next, Out2 is primed (Out2 Mix Prime=2), to minimize transfer of air bubbles to BPumps. This is a fourth programmed RNA loss, as up to 1 ul out of 15 ul (6.7%) is sacrificed. Therefore, yield after all programmed losses can be as low as 93.3% of 85%=79%. Finally, bead/RNA/water mixture is pumped through BPumps to elution ports E (BPump_El2Elute=30). To maximize bead capture, a dwell time (EluteDwell=1500) is introduced into each pump cycle.

### B. Method for Performing Enzyme Reactions

Scripts can be written to operate and/or automate the systems, devices, and methods described herein. The following is an example of a script for performing the enzyme reactions described herein.

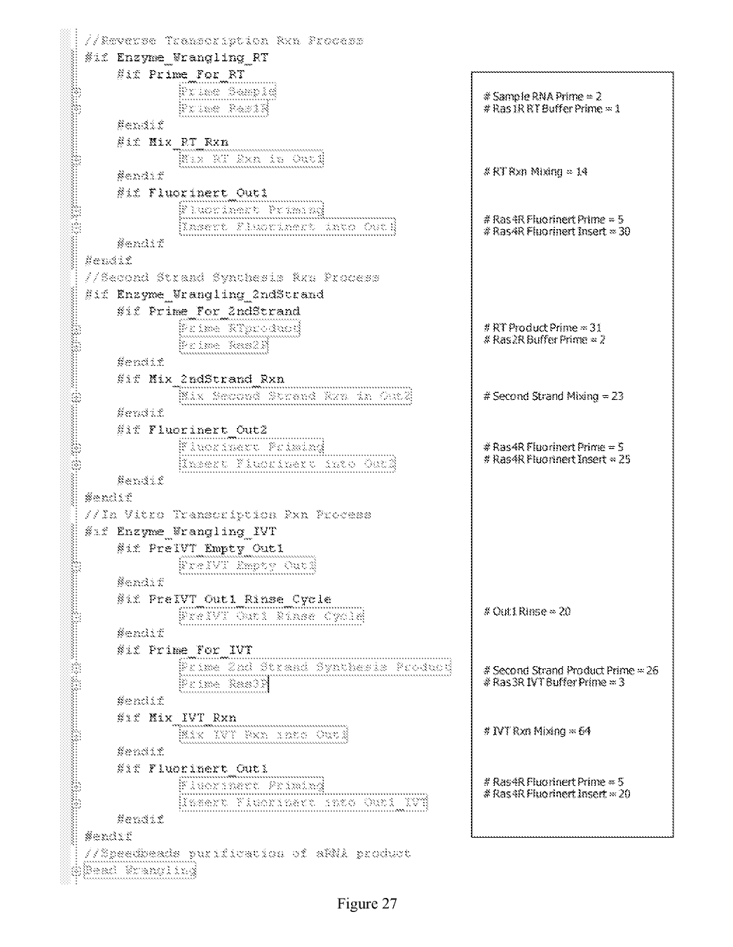

As shown in FIG. 27, the script for the three-step Eberwine chemistry is organized into three sections for Reverse Transcription (RT), Second Strand (SS) Synthesis, and In Vitro Transcription (IVT), respectively. Each section has in common three steps: (i) buffer priming, (ii) reaction mixing, and (iii) Fluorinert insertion. Priming removes air to ensure precise volume control of mixed solutions. Fluorinert insertion, after mixing, elevates the reaction mixture into the pipette tip for best contact with the TEC-Tip Manifold, and also eliminates evaporation during extended incubations. Any inert fluid can be used in place of Fluorinert. In some embodiments, Fluorinert 77 is used. Inert fluids of low viscosity can be chosen. (Mineral oil is manually layered onto the top surface of reaction mixtures to eliminate evaporation from the top surface. Details of the enzyme reaction script are discussed below. Note that, in this script, all pump cycles are executed by chip pumps (Pump). Chip-to-chip pump rates vary from 0.55 uL to 0.70 uL per stroke. Use of layering liquids, e.g., the fluorinert or the mineral oil, can improve the reliability or reproducibility of the experiments. For example, repeated experiments can have results that are within 0.01, 0.1, 1, 2, 3, or 5 percent of each other. The standard deviation as a percent of the average value across repeated experiments can be less than about, up to about, or about 0.01, 0.1, 1, 2, 3, or 5 percent. The result can be amplification yield, array hybridization for a particular standard or entity, or any other relevant result.

1. Prime_for_RT. RNA (Sample) and RT reaction buffer (Ras1R) are primed consecutively (# Sample RNA=2 and # Ras1R RT Buffer=1). Note each priming cycle consists of two pump strokes that direct priming waste to RasWB and RasWR, respectively. The new zero-priming manifold system ensures only 1 or 2 strokes of priming is needed to get rid of air dead volume.

2. Mix_RT_Rxn. The 10 ul RT reaction is mixed from 5 uL total RNA and 5 uL Ambion buffer (enzymes added). RNA (Sample) and RT Reaction Buffer (Ras1R) are mixed in a 1:1 ratio into Out1. Note that the # RT Rxn Mixing=14, as opposed to 10 cycles for 10 uL. As discussed below, this is to compensate for potential losses during the enzyme reaction run.

3. Fluorinert_Out1. Fluorinert is first primed (# Ras4R Fluorinert Prime=5), and then pumped to Out1 (# Ras4R Fluorinert Insert=30).

The reaction is now incubated at 42C for 2 hr.

4. Prime_for_{—}2ndStrand. RT product (Out1) and Second Strand Buffer (Ras2R) are primed consecutively (# RT Product=31 and # Ras2R Buffer=2). Each Ras2R priming cycle has two pump strokes that direct priming waste to RasWB and RasWR, respectively. Note that since the Ambion kit provides excess Second-Strand Buffer, Ras2R is primed more (compared to Ras1R) to provide for additional purging of chip channels. Each RT product (Outl) priming cycle has only one pump stroke, directed to RasWB. Note that 31 strokes (one more than the 30 strokes for inserting Fluorinert) are used to completely remove the Fluorinert spacer. This could potentially lead to the loss of some RT product, and this is why we started with excess RT reaction mixture.

5. Mix_{—}2ndStrand_Rxn. The 30 ul SS reaction is mixed from 10 uL RT reaction product and 20 uL Second-Strand Buffer (enzymes added). RT product (Out1) and Second-Strand buffer (Ras2R) are mixed with 23 cycles to Out2 (# Second Strand Mixing=23). Each mixing cycle consists of two pump strokes of Second-Strand Buffer and one pump stroke of RT product (mixing ratio 2:1).

6. Fluorinert_Out2. Fluorinert is first primed (# Ras4R Fluorinert Prime=5), and then inserted into Out2 (# Ras4R Fluorinert Insert=25).

The reaction is now incubated at 16C for 1 hr, and 65C for 10 min (heat-kill).

7. PreIVT_Empty_Out1. To ensure that Out1 is completely empty, 10 pump cycles (hardwired into the script) empty Out1 to RasW.

8. PreIVT_Out1_Rinse_Cycle. Out1 is filled with 10 ul (# Out1 Rinse=20) water, and then emptied to RasW.

9. Prime_for_IVT. Second-Strand product (Out2) and IVT Buffer (Ras3R) are primed consecutively (# Second Strand Product=26 and # Ras3R Buffer=3). Each Ras3R priming has two pump strokes to RasWB and RasWR, respectively. The Ambion kit provides excess Second-Strand Buffer, so Ras3R is primed more times to provide additional purging of chip channels. Each RT product (Out1) priming has only one pump stroke, directing priming waste to RasWB. Note that # Second Strand Product Prime=26 in order to completely remove the Fluorinert spacer.

10. Mix_IVT_Rxn The 60 ul IVT reaction is mixed in Outl from 30 uL Second-Strand reaction product and 30 uL IVT Buffer (enzymes added) with 64 cycles (# IVT Rxn Mixing=64). Mixing ration is 1:1.

11. Fluorinert_Out1 Fluorinert is first primed (# Ras4R Fluorinert Prime=5), and then inserted into Outl (# Ras4R Fluorinert Insert=20).

The reaction is now incubated at 40C for 2 hr.

### C. Recovery of RNA using SPRI Chemistry

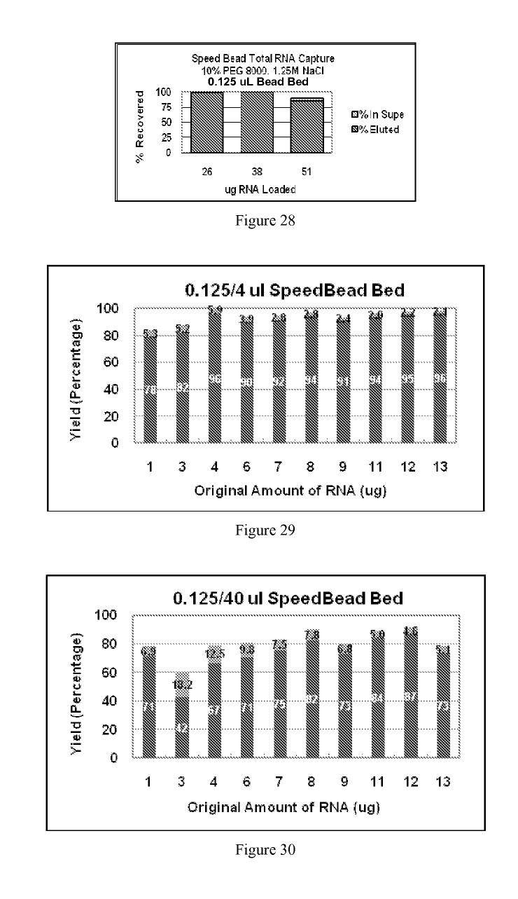

We obtained SpeedBeads from Seradyne, and created our own binding buffer. We used the buffer of DeAngelis et al. (Nucl. Acids Res. (1995) 23, 4742-4743) which comprises 20% PEG 8000, 2.5M NaCl (2× concentration). As shown in FIG. 28 (Which shows RNA purification using 0.125 uL SpeedBeads), bench experiments with SpeedBeads and DeAngelis buffer showed that at least 50 ug of total RNA could be purified with very high efficiency with a 0.25 ul packed bead bed. As shown in FIG. 29 (which shows RNA purification using 0.125/4 uL), equivalent results were obtained with ¼ the amount of SpeedBeads (13 ug×4=52 ug). And surprisingly, as shown in FIG. 30 (which shows RNA purification using 0.125/40 uL), even with 10× fewer SpeedBeads (0.125/40 ul) there was no sign of saturation up to 13 ug RNA (equivalent to 13 ug×40=520 ug), although recovery was reduced. Interestingly, in the experiment of FIG. 30, significant amounts of RNA were not recovered in the supernatant, indicating that bead loss, rather than bead saturation, was probably responsible for reduced RNA recoveries. These results indicate that 0.125 ul packed bead beds in chips should be capable of purifying at least 100 ug RNA with high efficiency.

### D. Microfluidic RNA Recovery

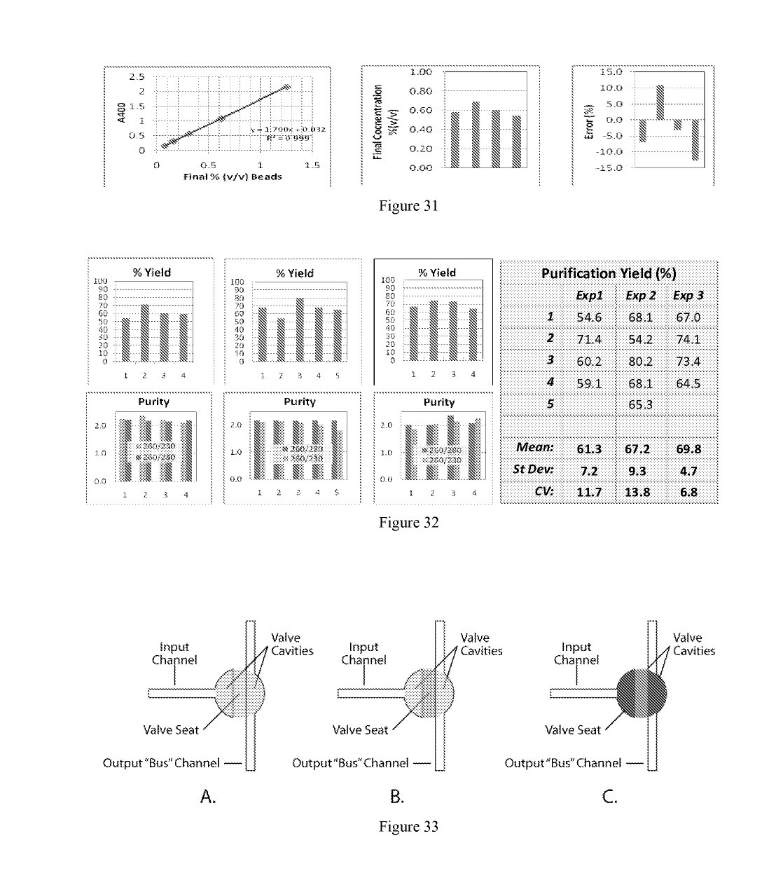

The accuracy of mixing of RNA and 2XBB (actually dilution of 2XBB with water) was first characterized. This experiment relied on our observation that SpeedBead concentration can be sensitively monitored by absorbance at 400 nm (FIG. 31, left). FIG. 31 (right) shows that the % mixing error for four experiments was approximately +/−15%. FIG. 31 shows Bead Mixing Accuracy FIG. 31 Left shows a Standard curve relating bead concentration to A400. FIG. 31 Middle shows Final bead concentration after 1:1 dilution of 1.25% beads in 2XBB by Mix_Out2 code chunk on a chip of this invention 1. FIG. 31 Right shows % mixing error. Most of this is likely attributable to pump filling inaccuracies caused by the relatively high viscosity of 2XBB. The sensitivity of RNA purification efficiency to this mixing ratio is presently uncharacterized.

FIG. 32 shows the results of three purification experiments with approximately 1.5 ug total RNA in a chip running the script. FIG. 32 shows Purification Yield and Purity. FIG. 32 Left shows Experiment 1 using 1.6 ug RNA. FIG. 32 Middle shows Experiment 2 using 1.7 ug RNA. FIG. 32 Right shows Experiment 3 using 1.7 ug RNA and increased # Binding Rxn Loader to 41. These results are also summarized in the FIG. 32 table. Average purification efficiencies were 61.3% to 69.8%, which is approximately 10-20% lower than the programmed RNA losses described above (expected yield as low as 79%). In addition to the programmed losses, additional losses may be incurred due to poor RNA-bead association, RNA or beads sticking to walls, etc. In this respect, one significant loss that we have consistently observed is the accumulation of beads in the dead volume formed by the adhesive layer attaching the chip to the fluidic manifold during transfer of bead binding mix to BPumps (step 4 above). We suspect that it is possible that up to 10% of the beads may become immobilized in this dead volume. Taking this additional loss into account, expected purification efficiencies should run around 70%.

With respect to purification efficiency, it is probably worth noting that Exp 3, in which # Binding Rxn Loader was increased from 39 to 41 had the highest mean and lowest CV among the three experiments. This indicates that the problem of bubble injection into BPumps may have been over-estimated.

The above described experiments were conducted with relatively small amounts of RNA (<5 ug) and small purification volumes (20 ul). In experiments with Message Amp III aRNA (15 ug) and liquid volume (120 ul) levels, additional effects on bead capture efficiencies were observed. The result of these effects was decreased bead capture and RNA purification efficiencies (about 50%, as discussed below). At present we believe that there are five major factors affecting bead capture and RNA purification efficiencies under Message Amp III conditions.

1. Membrane Deformation. Efficient bead capture in BPumps relies on deformation of the PDMS membrane to the bottom of the 500 um milled-out pneumatic layer. The major factors affecting deformation are membrane modulus (flexibility), membrane thickness, and vacuum level. Experiments with different PDMS thicknesses and chemistries have shown that while increased membrane flexibility can improve deformation, bead collection efficiency, and RNA purification efficiency, it also decreases valve pressure operating margins. As illustrated in FIG. 33, this is because, when valves are closed, increased flexibility allows the membrane to deform up into valve cavities, cutting-off flow in “Bus” channels. Although this undesirable behavior can be reduced by decreasing valve closing (positive) pressures, this tends to increase valve leakage phenomena, generally degrading chip performance. FIG. 33 shows Bus Channel Cut-Off. PDMS membrane (red) deformation in three valve states. FIG. 33 A shows an Open Valve. The membrane is pulled down into the pneumatic layer. FIG. 33 B shows a Closed Valve. In normal operation, the membrane seals against valve seat, closing the valve. Flow through the Bus Channel is unimpeded. FIG. 33 C shows a Bus Channel Cutoff. With increased flexibility, membrane can deform up into valve cavities, cutting-off flow in the Bus Channel. Alternatively, chips can be designed without Bus channels by ensuring that valve cavities and input/output channels never overlap. Although this is a straightforward change, it decreases design flexibility. Fortunately, increased vacuum levels can improve membrane deformation into the pneumatic cavity without affecting valve closing phenomena. The relatively low vacuum pressure (18-21 in Hg) produced by the Hargraves pumps used throughout the project can be improved with stronger pumps, such as the KNF UN86. Vacuum levels exceeding 28 in Hg can be achieved, resulting in improved bead capture and RNA purification efficiencies.

2. Magnetic Field. Magnetic field strength and bead capture efficiencies can be increased with larger magnets. However, unless careful field shaping and magnetic shielding is implemented, stray fields throughout the chip may tend to capture beads in undesired locations, decreasing chip operating efficiency.

3. Buffer Viscosity. We have routinely observed that bead collection efficiencies are highest in water, and lowest in Bead Binding Buffer. The reason for this difference may be the high viscosity of the buffer, which is due to the presence of 10% PEG8000.

4. Pumped Volume. We have also observed that bead capture efficiency is affected by the pumped volume. This is probably because, for a constant quantity of beads, increased pumped volumes result in greater net hydrodynamic drag on the beads, and therefore, greater bead losses from BPumps.

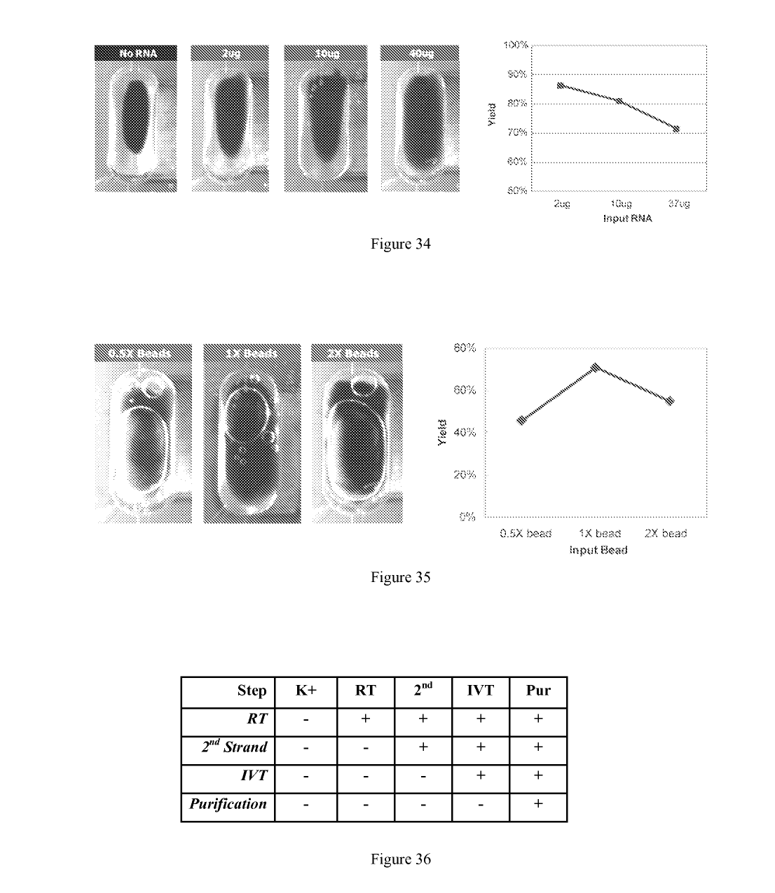

5. RNA Quantity. We have recently observed an interesting and unexpected phenomenon associated with purification of relatively large amounts of RNA in chips of this invention. As shown in FIG. 34, the distribution of beads is a strong function of the amount of RNA bound to them, and association of increasing amounts of RNA with the beads produces progressively more diffuse (less concentrated) bead collection patterns. FIG. 34 shows RNA Effect On Bead Collection and Purification Efficiency. The indicated quantities of Rat Liver Total RNA were captured on 0.125 ul of SpeedBeads and RNA was purified for quantitation. Diffuse bead collection patterns are associated with increased bead losses due to hydrodynamic drag. As expected, RNA purification yield drops from nearly 90% at 2 ug to about 70% at 40 ug. This phenomenon is not evident in bench control experiments (FIG. 28, FIG. 29, and FIG. 30). This phenomenon may be due to electrostatic repulsion of RNA. However the high salt concentration of 1× Bead Binding Buffer (1.25M NaCl) may significantly shield such ionic effects. Another possibility is that RNA association renders beads “sticky”, causing them to adhere to (for example) the PDMS membrane as they encounter it. This might then prevent beads from concentrating by “falling down” into the deeper parts of the membrane. As shown in FIG. 35 (left), bead distribution does not appear to be strongly dependent on bead quantity, as 0.5× and 2× beads also failed to concentrate. Interestingly however, as shown in FIG. 35 (right), RNA purification efficiency does appear to be a strong function of bead quantity, as 0.5× and 2× beads yielded less purified RNA. It is perhaps surprising that 1× beads turned out to be optimal. FIG. 35 shows RNA Effect as a Function of Bead Quantity. Forty ug of Rat Liver Total RNA was captured on the indicated quantities of beads. 1× beads is 0.125 ul SpeedBeads. This quantity of beads was chosen early in the project based on observations suggesting that this is the maximum amount that can be efficiently captured in the BPump. These observations suggest, therefore, that decreased at 2× beads may be due to RNA purification efficiency BPump overload. Decreased RNA purification efficiency at 0.5× beads may be due to increased non-specific bead losses in the chip and/or increased bead dispersion due to either increased electrostatic repulsion or stickiness.

### E. Enzyme Reaction

Ambion Message Amp III reactions were sequentially and progressively checked after each reaction step on-chip, as indicated in

FIG. 36.

Exp 1 (+K, all off-chip) served as a positive control for the standard Message Amp III kit. The products of Exps 2-5, in which increasing numbers of steps are carried out on-chip, are then be compared to Exp 1. aRNA quantity and quality was monitored by absorbance, gel electrophoresis, and capillary electrophoresis (Agilent BioAnalyzer), which were also used to characterize aRNA size distributions. Strategene Universal Human Reference (UHR) RNA was used as starting material.

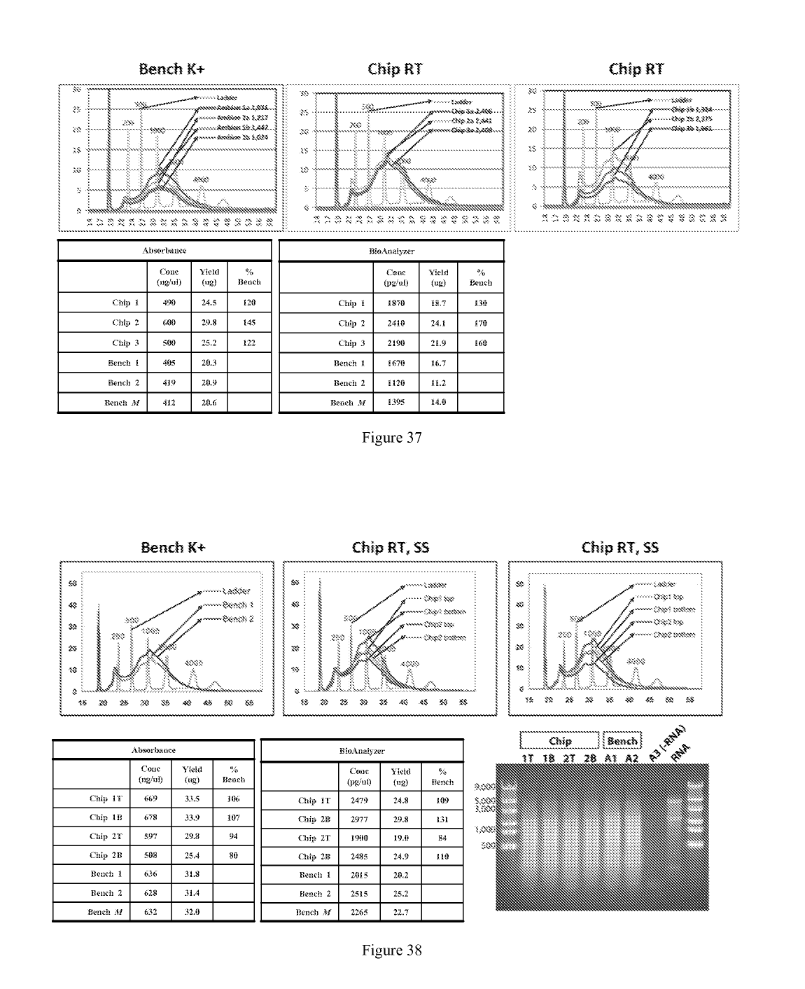

Exp 2: Reverse Transcription (RT) Reaction. The results of on-chip RT reactions are shown in FIG. 37. Chip and bench Bioanalyzer size distributions appear similar, and surprisingly, the yield from chip-based RT is higher than the bench control. This may be attributable to inadvertently extended RT incubation times for the chip-based reactions.

FIG. 37 shows Exp 1 (Bench Positive Control, K+) and Exp 2 (Chip, RT). BioAnalyzer and UV absorbance characterization. Approximately 415 ng of UHRR was used for bench positive control and chip-based RT reactions. Incubations were as follows: 42C/30 m (RT), 16C/60 m (SS), 65C/10 m (Kill), and 40C/120 m (IVT). Note that reaction times are shorter than Message Amp III. Each sample was run twice on the BioAnalyzer.

Exp 3: Second-Strand (SS) Reaction. The results of on-chip RT and SS reactions are shown in FIG. 38. Chip and bench size distributions and yields appear similar.

FIG. 38 shows Exp 1 (Bench Positive Control, K+) and Exp 3 (Chip SS). BioAnalyzer, UV absorbance, and agarose gel characterization. Approximately 415 ng of UHRR was used for bench positive control and chip-based RT reactions. Incubations were as follows: 42C/30 m (RT), 16C/60 m (SS), 65C/10 m (Kill), and 40C/120 m (IVT). Note that reaction times are shorter than Message Amp III. Each sample was run twice on the BioAnalyzer. Lane A3 on the gel is a —RNA bench negative control, lane RNA is UHRR starting material.

Exp 4: In-Vitro Transcription (IVT) Reaction. The results of on-chip RT, SS, and IVT reactions are shown in FIG. 40. Chip and bench size distributions and yields appear similar. FIG. 40 shows Exp 1 (Bench Positive Control, K+) and Exp 4 (IVT). BioAnalyzer, UV absorbance, and agarose gel characterization. Approximately 230 ng of UHRR was used for bench positive control and chip-based RT reactions. Incubations were as follows: 42C/30 m (RT), 16C/60 m (SS), 65C/10 m (Kill), and 40C/120 m (IVT). Note that reaction times are shorter than Message Amp III. Each sample was run twice on the BioAnalyzer. Lane A3 on the gel is a —RNA bench negative control, lane RNA is UHRR starting material.

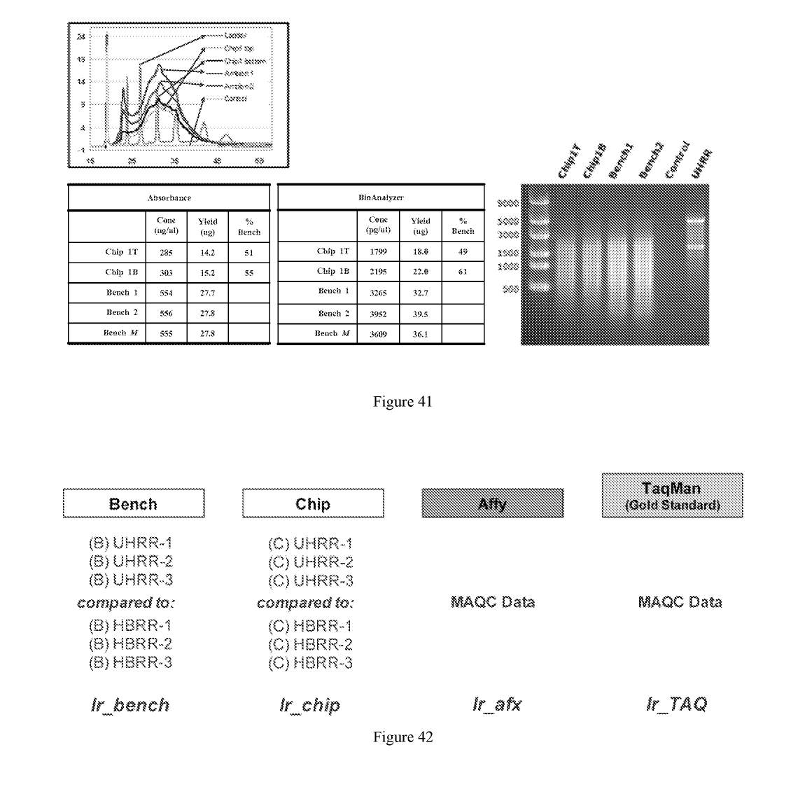

Exp 5: Purification. The results of on-chip RT, SS, IVT reactions and purification are shown in FIG. 41. Chip and bench size distributions appear similar, however chip yields were only about 50% of bench. This is likely attributable to inefficient chip-based purification due to bead loss.

FIG. 41 shows Exp 1 (Bench Positive Control, K+) and Exp 5 (RNA Purification). BioAnalyzer, UV absorbance, and agarose gel characterization. Approximately 310 ng of UHRR was used for bench positive control and chip-based RT reactions. Incubations were as follows: 42C/30 m (RT), 16C/60 m (SS), 65C/10 m (Kill), and 40C/120 m (IVT). Note that reaction times are shorter than Message Amp III.

Yields and amplification factors are summarized in the tables shown in

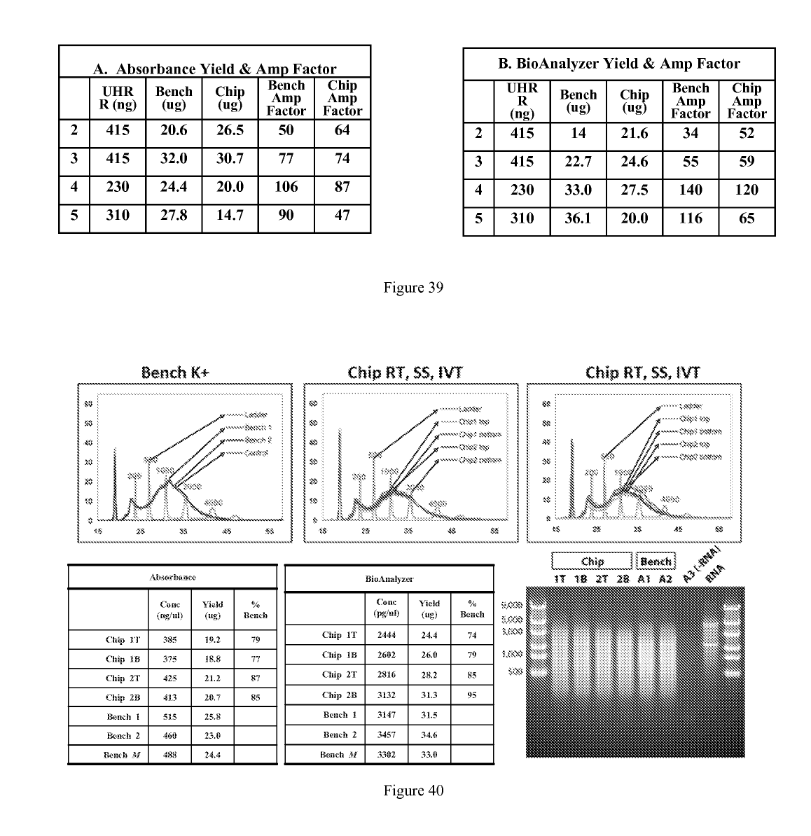

FIG. 39. In general, amplification factors and input amount are inversely related, as expected. Overall, the data show that enzyme reactions are efficiently carried out in the breadboard system.

### F. Microarray Analysis

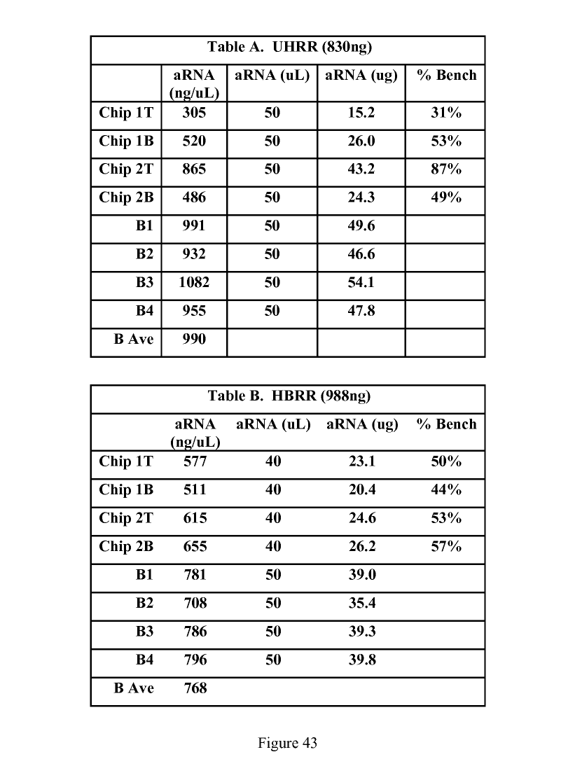

Bench- and chip-generated aRNAs were compared on Affymetrix U133 Plus 2.0 whole genome microarrays. The experiment was designed along the lines of the Microarry Quality Control (MAQC) study so that results could be compared to industry standards. Consistent with MAQC, amplified RNAs were generated from two different RNA inputs: Stratagene UHRR and Ambion Human Brain Reference RNA (HBRR). The design of the experiment is outlined in FIG. 42. After bench- or chip-synthesis, all aRNAs were fragmented with Ambion Message Amp III reagents for 30 minutes at 94C, and shipped to Expression Analysis on dry ice.

FIG. 42. Microarray Experimental Design. Four sets of three samples were generated: Bench (B) UHRR and HBRR, and Chip (C) UHRR and HBRR. Affy and TaqMan MAQC data were used for comparison. Results were expressed as log ratio (lr) of averaged UHRR and HBRR data.

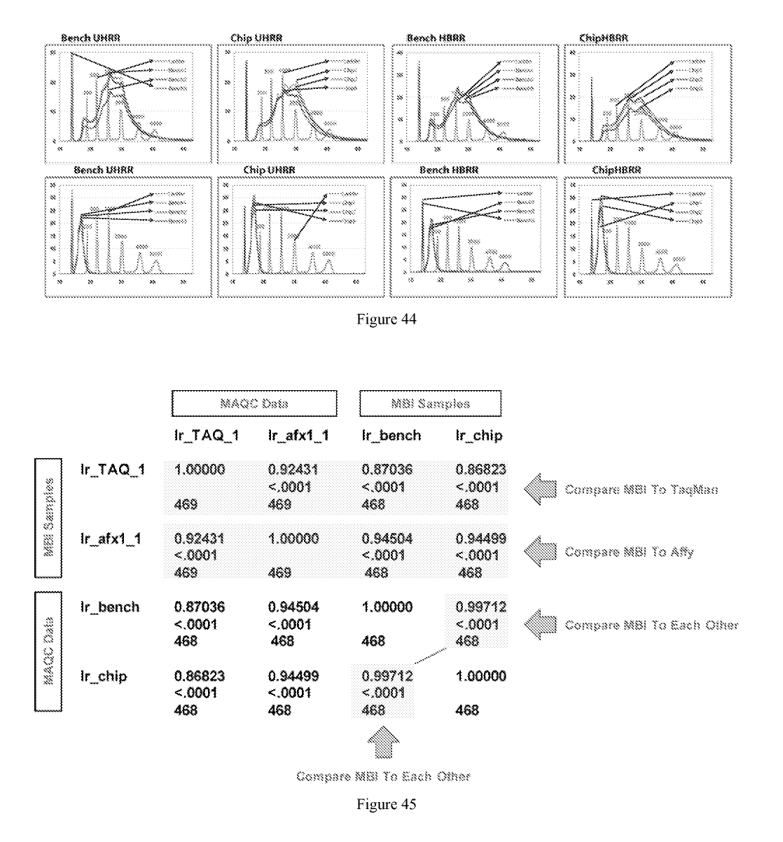

Tables A and B shown in FIG. 43 show aRNA yields for the bench- and chip-generated samples. FIG. 44 shows BioAnalyzer electropherograms of the samples before and after fragmentation. The key results of the experiment are summarized in FIG. 45, which shows a 4×4 matrix comparing the four log-ratio samples defined in FIG. 42.

FIG. 44 shows UHRR and HBRR aRNA Electropherograms. FIG. 44 Top shows Before Fragmentation. FIG. 44 Bottom shows After Fragmentation.

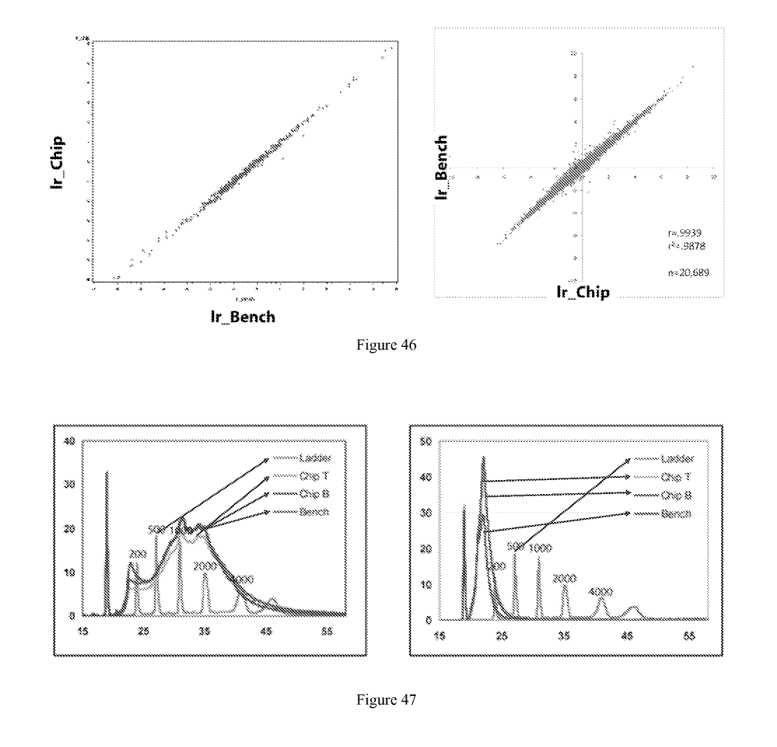

As noted above, the primary purpose of this experiment was to compare Bench and Chip aRNAs. The results in FIG. 45 and FIG. 46 clearly show that these two samples are very highly correlated (Pearson Correlation Coefficient=0.99712). The data also appear to show that MAQC Affymetrix samples are more highly correlated to MAQC TaqMan (0.92431) than either of the samples; Bench (0.87036) or Chip (0.86823). However, additional bootstrap re-sampling analysis has shown that this difference is not statistically significant.

FIG. 45 shows Microarray Results 4×4 Comparison Matrix. Four data sets are compared: MAQC TaqMan (lr_TAQ_1), MAQC Affymetrix (lr_atx_1), Bench (lr-bench), and Chip (lr_chip). Each matrix entry has three components (top-to-bottom): Pearson Correlation Coefficient, Prob>|r|, and Number of Observations. Prob>|r| is the probability that the corresponding correlation is zero. Number of Observations (469) is the number of transcripts in the MAQC study detected in both TaqMan and Affymetrix data sets.

FIG. 46 shows Chip vs Bench Comparisons. FIG. 46 Left shows Over 468 MAQC-Common Transcripts. FIG. 46 Right shows Over 20,689 Common Transcripts.

### G. Fragmentation

In addition, we have also recently implemented the fragmentation step of the microarray workflow (FIG. 24A) on the system using Ambion Message Amp III chemistry. Briefly, purified aRNA from E12 was mixed with Fragmentation Buffer (4:1 ratio) from Ras4B into Out2. Fluorinert was then pumped behind the mixture, and mineral oil was layered on top. The mixture was then incubated at 94C for 35 minutes, removed from the pipette tip, and analyzed. The results shown in FIG. 31 show that chip- and bench-fragmentation are indistinguishable.

FIG. 47 shows On-Chip Fragmentation. FIG. 47 Left shows aRNA Before Fragmentation. FIG. 47 Right shows aRNA After Fragmentation.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A device comprising:
(a) a cartridge;
(b) a microfluidic chip having one or more microfluidic diaphragm valves, fluidically interfaced with the cartridge; and
(c) a base comprising a support structure, one or more temperature controlling devices that are in thermal contact with the cartridge, and pneumatic lines for pneumatically actuating the microfluidic chip.

2. The device of claim 1, wherein the base further comprises a pneumatic floater that is positioned within the support structure.

3. The device of claim 2, wherein the pneumatic floater is supported by springs that force the pneumatic floater toward the microfluidic chip.

4. The device of claim 2, wherein the pneumatic floater is supported by springs that allow for an air-tight seals between the pneumatic floater and the microfluidic chip.

5. The device of claim 1, wherein the support structure is rigid.

6. The device of claim 1, wherein the base further comprises a pneumatic insert that is fluidically connected with the cartridge.

7. The device of claim 1, wherein the cartridge comprises a thermistor.

8. The device of claim 1, wherein the cartridge is formed from cyclic olefin copolymer.

9. The device of claim 1, wherein the cartridge is injection molded.

10. The device of claim 1, wherein the support structure is a heat sink.

11. The device of claim 1 wherein the device further comprises a pneumatic manifold mounted on the base, wherein the pneumatic manifold comprises vias or channels that are in pneumatic communication with the pneumatic lines and with pneumatic ports on the microfluidic chip to deliver pressure or vacuum to the chip to actuate the diaphragm valves, and wherein the pneumatic manifold is mounted on the support in a configuration biased to engage the chip and to allow the temperature controlling devices also to be in thermal contact with the cartridge.

12. A device comprising:
(a) a microfluidic chip having one or more pneumatically actuated valves and one or more chambers; and
(b) a cartridge, wherein the cartridge comprises one or more reservoirs that are fluidically connected with the chambers and the reservoirs are sized such that a material can be directly pipetted into the chamber.
